(19) United States
(12) Patent Application Publication
(10) Pub. No.: US 2012/0312714 A1
(43) Pub. Date: Dec. 13, 2012

(54) TACTILE AND LOW-VISION INDICATION PACKAGING SYSTEM AND APPARATUS

(76) Inventors: Robert A. Luciano, Reno, NV (US); Warren White, Reno, NV (US)

(21) Appl. No.: 13/526,412

(22) Filed: Jun. 18, 2012

Related U.S. Application Data
(63) Continuation-in-part of application No. 12/891,042, filed on Sep. 27, 2010.
Application No. 12/891,042 is a continuation-in-part of application No. 12/891,029, filed on Sep. 27, 2010.
Application No. 12/891,029 is a continuation-in-part of application No. 12/424,475, filed on Apr. 15, 2009, now Pat. No. 8,146,747.
Application No. 12/424,475 is a continuation-in-part of application No. 12/418,436, filed on Apr. 3, 2009, now abandoned.
Application No. 12/418,436 is a continuation-in-part of application No. 11/923,321, filed on Oct. 24, 2007, now Pat. No. 8,266,878.
Application No. 11/923,321 is a continuation-in-part of application No. 11/796,124, filed on Apr. 25, 2007, now Pat. No. 8,074,426.
Application No. 11/796,124 is a continuation-in-part of application No. 11/241,783, filed on Sep. 30, 2005, now Pat. No. 8,123,036.
(60) Provisional application No. 61/498,489, filed on Jun. 17, 2011.
(60) Provisional application No. 61/245,912, filed on Sep. 25, 2009.
(60) Provisional application No. 61/245,899, filed on Sep. 25, 2009.
(60) Provisional application No. 61/045,160, filed on Apr. 15, 2008.
(60) Provisional application No. 61/045,166, filed on Apr. 15, 2008.
(60) Provisional application No. 61/045,171, filed on Apr. 15, 2008.
(60) Provisional application No. 61/042,262, filed on Apr. 3, 2008.
(60) Provisional application No. 61/042,263, filed on Apr. 3, 2008.
(60) Provisional application No. 60/854,341, filed on Oct. 24, 2006.
(60) Provisional application No. 60/795,370, filed on Apr. 26, 2006.
(60) Provisional application No. 60/795,446, filed on Apr. 26, 2006.
(60) Provisional application No. 60/795,413, filed on Apr. 26, 2006.
(60) Provisional application No. 60/615,267, filed on Oct. 1, 2004.

(51) Int. Cl. A61J 1/03; B65D 83/04

(52) U.S. Cl. 206/534

(57) ABSTRACT

A package for blind or low-vision patients is described. The package includes preliminary containers, a final package, a prescribed time of day for consuming the plurality of tablets, and a tactile indication. Each preliminary container includes a plurality of tablets. The final package receives the preliminary containers and dispenses the preliminary containers. The package includes a prescribed time of day for consuming the tablets that are enclosed by the preliminary containers that are housed by the final package. The tactile indication is associated with the prescribed time of day for consuming the tablets.

### CROSS-REFERENCE

The present patent application claims the benefit of provisional patent application 61/498,489 filed on Jun. 17, 2011 entitled TACTIBLE AND LOW-VISION INDICATION PACKAGING SYSTEM AND APPARATUS, and

is a continuation-in-part of patent application Ser. No. 12/891,0042 filed on Sep. 27, 2010 entitled LOW VISION PATIENT COMPLIANT MEDICATION MANAGEMENT SYSTEM AND METHOD that claims the benefit of provisional patent application 61/245,912 filed on Sep. 25, 2009, and

is a continuation-in-part of patent application of patent application Ser. No. 12/891,029 filed on Sep. 27, 2010 entitled DUAL DISPENSING TABLET CONTAINER that claims the benefit of provisional patent application 61/245,475 filed on Sep. 25, 2009, and

is a continuation-in-part of patent application Ser. No. 12/424,475 filed on Apr. 15, 2009 entitled TABLET DISPENSING CONTAINER that claims the benefit of provisional patent applications 61/045,160 filed Apr. 15, 2008, provisional patent application 61/045,166 filed Apr. 15, 2008, provisional patent application 61/045,171 filed Apr. 15, 2008, and

is a continuation-in-part of patent application Ser. No. 12/418,422 filed on Apr. 3, 2009 entitled PATIENT COMPLIANT MEDICATION MANAGEMENT SYSTEM AND METHOD that claims the benefit of provisional patent application 61/042,262 filed Apr. 3, 2008 and provisional patent application 61/042,263 filed on Apr. 3, 2008, and

is a continuation-in-part of patent application Ser. No. 11/923,321 filed on Oct. 24, 2007 entitled METHOD FOR VERIFYING AND ASSEMBLING A MULTOPLE PRESCRIPTION PACKAGE that claims the benefit of provisional patent application 60/854,341 having a filing date of Oct. 24, 2006, and

is a continuation-in-part of patent application Ser. No. 11/796,124 filed on Apr. 25, 2007 entitled MULTIPLE PRESCRIPTION PACKAGE AND METHOD FOR FILING THE PACKAGE that claims the benefit of provisional patent application 60//795,370 filed on Apr. 26, 2007, provisional patent application 60/795,446 having a filing date of Apr. 26, 2006, provisional patent application 60/795,413 having a filing date of Apr. 26, 2006, and

is a continuation-in-part of patent application Ser. No. 11/241,783 filed on Sep. 30, 2005 entitled PILL ASSEMBLY FOR PILL PACKAGING AND DELIVERY SYSTEMS that claims the benefit of provisional patent application 60/615,267 having a filing date of Oct. 1, 2004, and

all applications listed are hereby incorporated by reference.

### FIELD OF THE INVENTION

This invention relates to a tactile and low-vision indication packaging system and apparatus. More particularly, the tactile and low-vision indication packaging system and apparatus is associated with a particular dosage time for medications.

### BACKGROUND

One of the major problems in taking daily medications, including prescription medications, non-prescription medications and nutraceuticals emanates from patients having to take more than one medication in the form of tablets. A principal concern is determining whether all medications are in compliance with the prescribed/recommended daily regimen. Many times this concern is compounded by the requirement that portions of the different medications must be taken at different times during the day.

The fear of taking improper dosages of prescribed medication can be particularly acute in persons suffering from low-vision or blindness. Blindness is the condition of lacking visual perception due to physiological or neurological factors. Various scales have been developed to describe the extent of vision loss and define blindness. Total blindness is the complete lack of form and visual light perception and is clinically recorded as “no light perception.” Blindness is frequently used to describe severe visual impairment with residual vision. Those described as having only light perception have no more sight than the ability to tell light from dark and the general direction of a light source.

The leading causes of chronic blindness include cataract, glaucoma, age-related macular degeneration, corneal opacities, diabetic retinopathy, trachoma, and eye conditions in children, for example, vitamin A deficiency. Age-related blindness is increasing throughout the world, as is blindness due to uncontrolled diabetes, for example, age-related macular degeneration (AMD) is a medical condition which usually affects older adults and results in a loss of vision in the center of the visual field because of damage to the retina.

Approximately ten percent of those deemed legally blind, by any measure, have no vision. The rest have some vision, from light perception alone to relatively good acuity.

Blindness is distinguishable from color blindness. Color blindness or color vision deficiency is the inability or decreased ability to see color, or perceive color differences, under normal lighting conditions. Color blindness affects many people in a population. “Color blind” is a term of art; there is no actual blindness but there is a fault in the development of one or more sets of retinal cones that perceive color in light and transmit that information to the optic nerve. For purposes of this patent application, the term color blindness also refers to a low-vision patient.

Low-vision patients may be unable to access information regarding their own medications because they are not able to read standard text. For these reasons, such patients may have a difficult time complying with a medication regimen. Providing medications to disabled or incapacitated individuals can also be complicated because one caregiver may oversee the medication of many patients.

Solid dose medicines are typically sold in vials, with each specific medicine type and dosage in a separate vial. When multiple medications are required to be taken at the same time a patient will be required to extract the proper medicine from each vial. After the medicine is taken from the vial, there is no way to easily determine that it was actually taken. Also, typically the patient (or caregiver) is responsible for determining the proper medicine to take at the proper time. This can be particularly confusing when medicines or medicine groups need to be administered on an irregular schedule (i.e. once a week, every other day, etc.). One solution to the problem of taking multiple medications is to pre-package the multiple medications so that users can take the pre-packaged medications at a predetermined time.

There are compartmentalized sealed cups available commercially to assist patients and/or health care providers with this process. These, however, require the patient or caregiver to presort all medicines and to load them into their proper dosage period compartment, typically on weekly basis. This is time consuming and subject to human error. There are also some products that are commercially available or are available through institutionalized groups or hospitals that contain the presorted medicines in individual pouches. The individual pouches can be pre-labeled/printed with the proper time and date. However, there remains a need for compliance packaging that makes the dosage consumption time accessible to a person with limited or no vision.

### SUMMARY

A package for blind or low-vision patients is described. The package includes preliminary containers, a final package, a prescribed time of day for consuming the plurality of tablets, and a tactile indication. Each preliminary container includes a plurality of tablets. The final package receives the preliminary containers and dispenses the preliminary containers. The package includes a prescribed time of day for consuming the tablets that are enclosed by the preliminary containers that are housed by the final package. The tactile indication is associated with the prescribed time of day for consuming the tablets.

In one embodiment, the tactile indication includes at least one tactile symbol that provides a tactile representation that is associated with the prescribed time of day for consuming the tablets. In another embodiment, the tactile indication includes an alphanumeric character that is associated with the prescribed time of day for consuming the tablets. In yet another embodiment, the tactile indication is selected from the group consisting of a layered printing media, a thermographic printing media, a stamped printed impression, an embossed printed impression, a Braille indicia impression and an inkjet print impression.

The tactile indication associated with the prescribed time of day for consuming the tablets may be located on the preliminary package, the final package or the combination thereof.

A package for blind and low-vision patients that includes a color indicia combined with tactile indicia is also described. The color indicia is selected from the group consisting of white color, gray color, black color, pink color, red color, orange color, yellow color, green color, blue color, purple color and brown color.

### DRAWINGS

The present invention will be more fully understood by reference to the following drawings which are for illustrative, not limiting, purposes.

FIG. 1 is a perspective view of one embodiment of a spiral packaging system.

FIG. 2 is an exploded view of the spiral packaging system of FIG. 1.

FIG. 3 is a perspective view of the spiral packaging system of FIGS. 1 and 2 shown without the second shell portion and showing a plurality of containers.

FIG. 4 is a perspective view of one embodiment of a spiral packaging system shown with a medicament container.

FIG. 5 is another perspective view of the spiral packaging system of FIG. 4 shown without the medicament container.

FIG. 6 is a perspective view of a housing portion of the spiral packaging system of FIG. 5.

FIG. 7 is a perspective view of the spiral packaging system of FIG. 1 through FIG. 3 shown with a compliance wheel to provide a patient medication management system.

FIG. 8 is an exploded view of the patient medication management system of FIG. 7 shown with the compliance wheel removed.

FIG. 9 is a perspective view of another embodiment of a patient medication management system that includes tactile indicia with the compliance wheel.

FIG. 10 is a perspective view of the patient medication management system of FIG. 9 shown with the compliance wheel removed and with the internal shell components omitted for clarity.

FIG. 11 shows the second side of the housing of the patient medication management system of FIG. 10.

FIG. 12 shows an exploded view of the sprocket teeth viewed through an opening.

FIGS. 13A-13F are plan views of an embodiment of a compliance wheel modified for low-vision patients.

FIGS. 14A and 14B are perspective views of one embodiment of a medicament container.

FIG. 15 is a perspective view of a compliance wheel interacting with a medicament container.

FIG. 16 is a perspective view of one embodiment of a patient medication management system shown with a portion of the housing removed to illustrate interaction of a compliance wheel with a plurality of medicament containers.

FIG. 17 is a perspective view of a portion of a strip of medicament containers showing how one embodiment of audio compliance indicia is actuated.

FIG. 18 is a perspective view of one embodiment of spiral packaging system in a resting position.

FIGS. 19A-19E show a label strip usable with the patient medication management system.

FIG. 20 shows a perspective view of one embodiment of the spiral packaging system that includes Braille and audio indicia and precaution information.

FIGS. 21A-21C show perspective views of another embodiment of the spiral packaging system, including low-vision adaptive indicia.

FIG. 22 shows one set of illustrative tactile symbols that can be used with the spiral packaging system as a form of low-vision adaptive precaution indicia.

FIG. 23 shows one set of illustrative tactile symbols that can be used with the spiral packaging system as a form of low-vision adaptive dosage indicia.

FIGS. 24A-24C show perspective views of another embodiment of the spiral packaging system, including another form of low-vision adaptive indicia.

FIGS. 25A-25C show an isometric view of the dual tablet dispensing container.

FIGS. 26A-26E show a flat plan view of an illustrative label.

FIG. 27 shows a first side view of the front side wall for the unopened dual tablet dispensing container.

FIG. 28 shows a second side view of the back side wall of the 30-day tablet dispensing container.

FIGS. 29A-29B show a third side view of the illustrative right-side wall of the 30-day tablet dispensing container.

FIG. 30 shows a fourth side view of the illustrative left-side wall of the 30-day tablet dispensing container.

FIG. 31 shows a top view of the top wall of the unopened 30-day tablet dispensing container.

FIG. 32 shows a bottom view of the 30-day tablet dispensing container.

FIG. 33 shows an illustrative front view of the opened 30-day tablet dispensing container that reveals illustrative pouches.

FIG. 34A-34C shows a variety of different sealed center cut pouches.

FIG. 35 shows an illustrative layout of pouches associated with tablets be consumed at a particular date and time.

FIG. 36 shows a portion of the layout of a strip of pouches, in which the strip includes a header pouch.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and apparatus described hereinafter may vary as to configuration and as to details. Additionally, the methods may vary as to details, order of the actions, or other variations without departing from the illustrative methods disclosed herein.

The systems, apparatus and methods described herein provide correct medications and dosages at the appropriate times. The medications include, but are not limited to, pharmaceutical, nutraceuticals, vitamins, supplements, tablets, caplets, capsules, medications associated with a prescription, medications not associated with a prescription and any other medication that can be packaged in preliminary package, package or container. For purposes of the illustrative embodiment presented herein, the terms medication and tablet are used interchangeably.

For purposes of this patent, the terms “preliminary package,” package, blister, cup, primary package, and primary container are used interchangeably. Illustrative preliminary packages include a pouch, blister, vial, or any package that holds or houses a plurality of different medications. A preliminary package may exist in as a sealed preliminary package, e.g. pouch, or an unsealed preliminary package, e.g. blister cup.

The preliminary packages are then placed into a “final” package or dispenser housing such as a box container or sleeve. In the illustrative embodiment, the preliminary packages are dispensed by the final package. For purposes of this patent, the terms final package and housing are used interchangeably.

The patient medication management system and method described herein eliminates the worry of taking the wrong medication at the wrong time and eliminates the need to manually open and organize prescriptions each week. Furthermore, the system and method described herein gathers all the patient's medicines together in one package and clearly show the proper dosage time.

The systems, apparatus and methods described herein provide assurances of the proper dosages at the proper period. Additionally, caregivers and patients get the assurance that the patient is getting the right medications and staying compliant with those medications. Furthermore, a time saving solution for dispensing tablets, medications and vitamins is described.

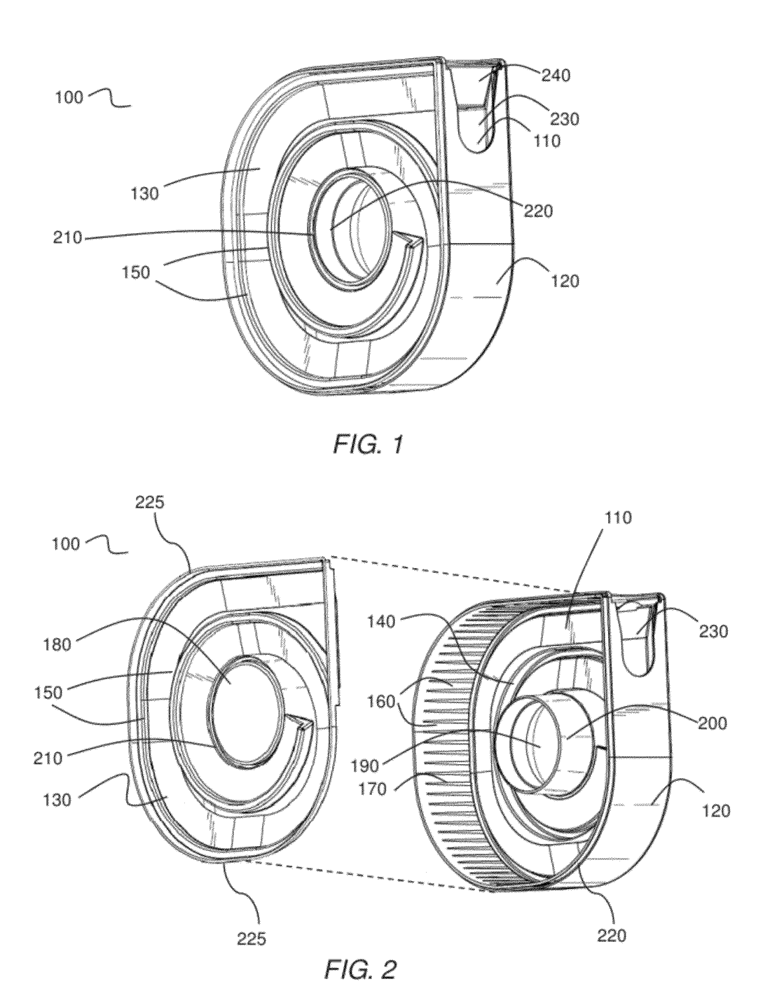

Referring now to FIGS. 1 through 3, there is shown one embodiment of a spiral packaging medication dispenser or system 100. The spiral packaging system 100 comprises first and second opposing shell portions 110, 130, and an outer wall 120. In the embodiment of FIG. 1 shell portions 110 and 130 are configured to fit together with outer wall 120 circumferentially positioned about shell portions 110, 130 to define or form a medication dispenser.

The first and second shell portions 110, 130 each include a spiral track 140 and 150 respectively. Tracks 140, 150 are configured to hold a plurality of medication receptacles or containers (not shown). Grooves or ridges 160 on the interior surface 170 of wall 120 aid in positioning the pill receptacles within the spiral packaging system 100 and advancing the receptacles along the tracks 140, 150 as described further below.

The first 110 and second 130 shell portions each include a central opening 180 and 190 respectively. First shell central opening 180 and second shell opening 190 each in turn include a circular edge or flange 200, 210 respectively. Flanges 200, 210 are structured and configured to engage each other and secure first and second shell portions 110, 130 together. In the embodiment of FIGS. 1 and 2, flange 200 is of slightly larger diameter than flange 210 such that flange 210 fits within flange 200 to hold shell portions 110, 130 together. Flanges 200 and 210 may be tapered as shown in FIGS. 1 and 2 to allow flanges 200, 210 to engage each other by tension and to provide the end user with an ergonomically friendly packaging system. Outer wall 120 includes a circumferential flange 220 that engages a corresponding lip 225 on second shell portion 130. Flange 220 and lip 225 interfit and engage each other to hold second shell portion 130 to wall 120. The central openings 180 and 190 in shell components allow the apparatus 100 to be rotatably mounted on a bracket or other element as described further below.

The outer wall 120 of spiral packaging system 100 further comprises an opening or dispensing aperture 230 configured to allow medication/pill receptacles or containers (not shown) to be removed or ejected from the spiral packaging system 100. The container aperture or opening 230 is positioned on the shell wall portion 120 of the apparatus and is of sufficient size to allow medicament containers to pass through sequentially or one at a time as described further below.

First shell 110, second shell 130, and wall portion 120 of the spiral medication packaging system 100 may be manufactured from molded plastics, composite materials, engineering resins, metals or metal alloys and the like, or combinations thereof. The various components of the apparatus 100 may be made of transparent, semi-transparent or opaque materials that aid the patient or caregiver in determining the amount of pill receptacles left in the spiral packaging system 100. First shell 110, second shell 130, and shell wall 120 may be manufactured separately and configured to enable the first 110 and second 130 shell portions to snap fit together or may be joined together using adhesives or other fastening means. In certain embodiments, either the first 110 or second 130 shell portion, and the shell wall 120 section may be manufactured as integral components of a single work piece (e.g. injected molded), with the remaining shell portion configured to attach thereto to form the spiral packaging system 100 by snap fitting, tensional engagement or other fastening means.

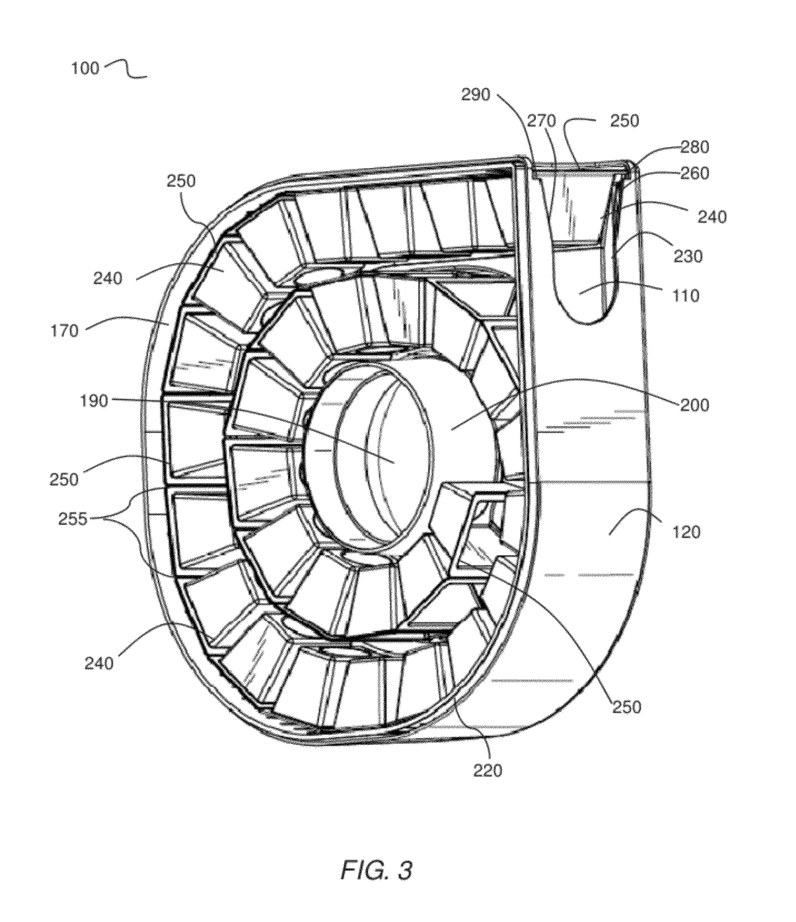

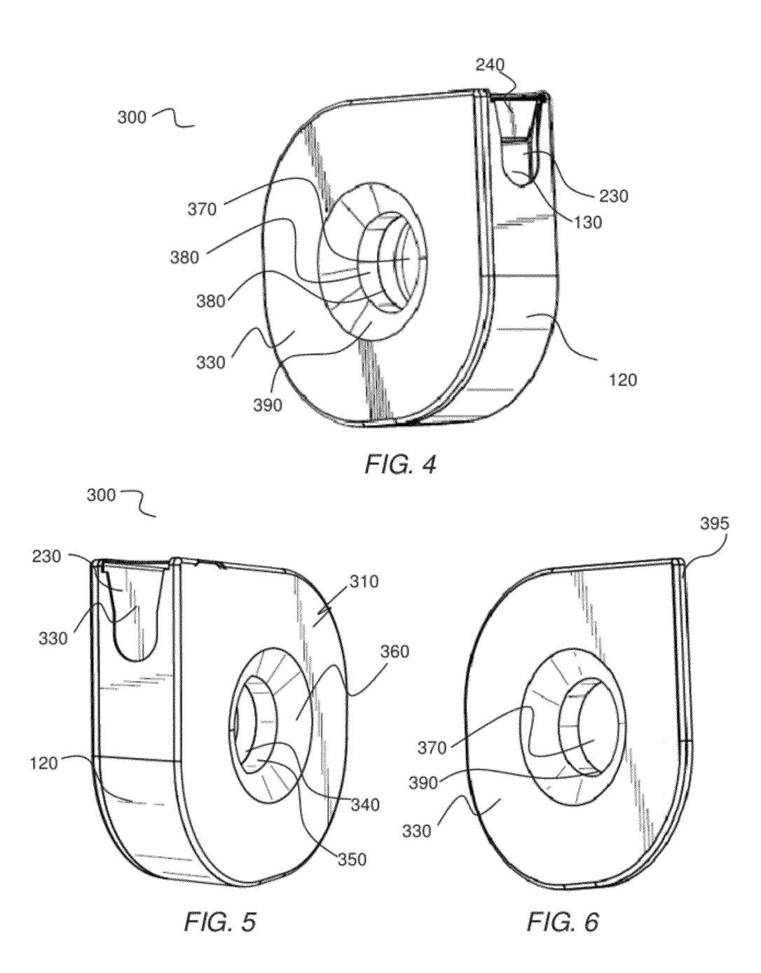

Referring also to FIG. 3, there is shown a perspective of the spiral packaging system 100 of FIGS. 1 and 2 with shell portion 130 removed to show a plurality of tablets or medicament containers 240 configured to hold tablets, caplets, pills, and other such medicaments. The containers 240 in this embodiment each comprise a flanged top edge 250 configured to fit into and interact with the interior spiral tracks 140 and 150 respectively of the first 110 and second shell 130 portions of the apparatus 100. The tubular flange 200 of the first shell central opening 190 aids in the alignment of the plurality of containers 240 within spiral tracks 140, 150. The top edge flanges 250 of adjacent containers 240 may be joined together by a frangible interface or connector 255 that is detached or broken by a user. Medicament containers 240 may be made, for example, of molded plastic or metal foil, or a combination thereof. Medicament containers as indicated at 240 may also include a frangible or removable top portion (not shown) as described below that may be penetrated or removed by user to access medication within containers 240.

The apparatus 100 in many embodiments is configured to hold approximately one month's supply that is generally a 30-day supply, but may also include 28 to 31 containers of a patient's medication. In some embodiments the spiral packaging system 100 may be configured to only hold one week of medication when the patient needs medication more than once a day. For example, when a patient will require three different medication dosages during a single day, the spiral packaging system 100 may be configured to support 21 containers (i.e. 3 doses per day X 7 days=21 containers). Various other numbers of containers may be used depending upon the particular use.

Container opening 230 in wall section 120 further comprises first and second edges 260, 270 that are configured to the shape of the containers 240 to allow the containers to pass through opening 230. First 260 and second 270 edges include top indentations 280 and 290 respectively that are configured to allow the flanged edge 250 of the container 240 to pass from the interior spiral groove(s) through the container opening 230 and out of the spiral packaging system 100. The container opening 230 in many embodiments is configured to include a childproof component (not shown) as is described further below.

In certain embodiments first and second shell portions 110, 130 are reversibly attachable and detachable to allow a user to open the apparatus 100 by detaching shell portions 110, 130 so that medicament containers 240 may be inserted into the apparatus 100, after which the shell portions are re-attached. The apparatus 100 is thus re-usable as the user can replace the medicament containers 240 therein when used up. In other embodiments the medicament containers 240 may be inserted into the apparatus 100 by a health care provider or pharmaceutical supplier, with shell portions 110, 130 then being permanently attached or adhered together so that the end user or patient cannot open the apparatus 100 or access the medicament containers 240 except via the dispensing aperture 230.

To use the apparatus 100, medicament containers 240 are arranged on track 140 or 150 in a spiral arrangement to conform to the shape of tracks 140, 150, with flanges 250 of containers fitting over the outer edge of tracks 140, 150. In many embodiments, medicament containers 240 are arranged in a linear chain with each medicament container 240 joined to adjacent containers 240 by the frangible interface 255. The medicament containers 240 are positioned so that the first container 240 is adjacent to opening 230 as shown in FIG. 3. Shell portions 110, 130 are then attached to each other, leaving the medicament containers arranged along tracks 140, 150. As the patient or user accesses the first medicament container 240 through dispensing aperture 230, the user pulls the first container 240 through aperture 230, with flanges 250 on containers 240 sliding along tracks 140, 150 and over indents 280, 290 of aperture 230. Opening 230 as shown is configured to allow a user to insert a finger through opening 230 to facilitate manipulation of container 240. As the first container 240 is withdrawn from aperture 230, the remaining containers 240 are advanced along tracks 140, 150 toward aperture 230. The grooves or ridges 160 on the interior surface 170 of wall 120 provide some friction to containers 240 so that containers 240 move at a convenient rate along tracks 140, 150. When the first or end-most container 240 has exited the apparatus 100 through aperture 230, the user detaches the first container 240 by breaking frangible interface 255. The next container 240 is positioned adjacent to aperture 230 and may be accessed in the same manner. When the last medication container 240 has been withdrawn from the apparatus 100, the apparatus may be disposed of or opened to insert new medicament containers 240 and used again.

Each medicament container 240 includes, for example, the required medication for a particular time period. For each such time period, the patient accesses the container 240 adjacent to opening 230, and as each container is advanced and detached, the next container 240, having therein the medication for the next time period, is advanced to opening 230 for use in the following time period. The apparatus may include a timing element and alarm element (not shown), such as an oscillating quartz crystal timing device and a sound chip interfaced thereto, with the timing device and alarm chip powered by a small battery. When the proper time for medication has arrived according to the timing device, the alarm device may make a beeping or other alarm noise to alert the patient.

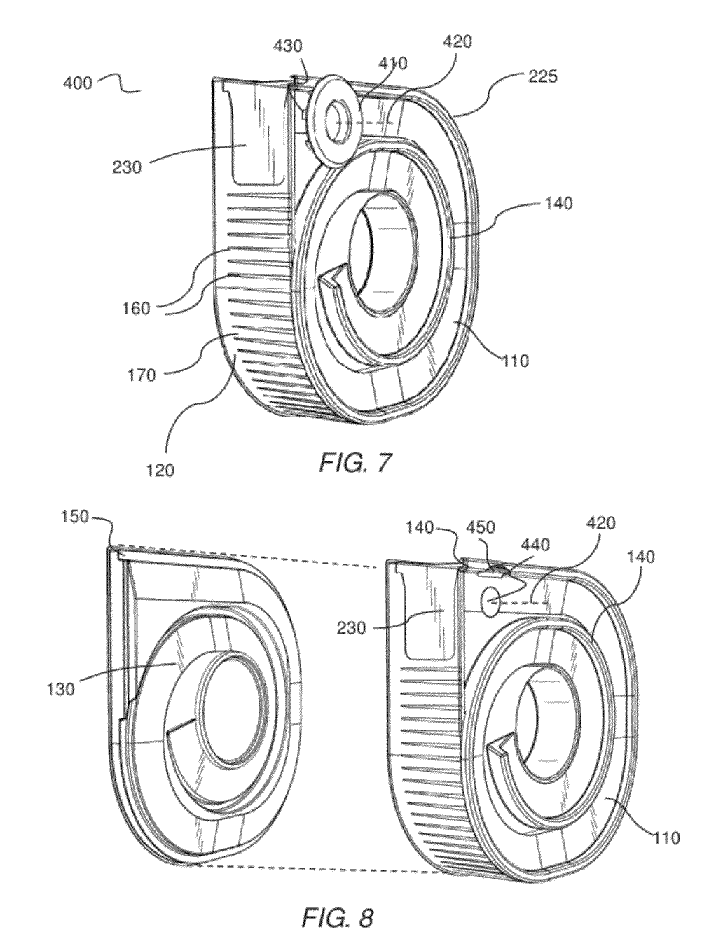

Referring now to FIGS. 4 through 6, there is shown another embodiment of a spiral medication dispenser or packaging system 300 in accordance with the invention, wherein like reference numbers are used to denote like parts. In the apparatus 300, first and second shell portions 110, 130 each include a corresponding first and second opposing facing or housing element 310, 330. Housing element 310 includes a central opening 340, a circular flange 350 surrounding opening 340, and a tapered region 360 surrounding flange 350. Housing element 330 similarly includes a central opening 370, a flange 380 surrounding the opening 370, and a tapered region 390 surrounding flange 380.

Housing elements 310, 330 are structured and configured to fit over first and second shell portions 110, 130 (FIGS. 1-3) respectively. In this regard, flanges 350, 380 are designed to fit over flanges 200, 210 of shell portions 110, 130, and tapered portions 360, 390 accommodate tracks 140, 150 of shell portions 110, 130 respectively. Housing elements 310, 330 include an outer flange 395 that is structured and configured to engage or otherwise interface with the outer lip 225 on shell portions 110, 130. Housing elements 310, 330 provide flat, smooth, easily cleanable outer surfaces to the apparatus 300 that allows facile handling and is pleasing to users. Housing elements 310, 330 facilitate inclusion of compliance and/or child proofing elements as described further below. In other respects the apparatus 300 operates and is generally used in the same manner as described above for the apparatus 100.

Referring now to FIG. 7, there is shown yet another embodiment of a spiral medication packaging system 400, wherein like reference numbers denote like parts. The spiral packaging system 400 shown in FIG. 7 comprises a compliance or drive wheel or sprocket 410 rotatably mounted on the first shell portion 110 of the apparatus 400 such that the compliance wheel 410 can rotate about a center axis 420. The wheel 410 includes a plurality of teeth 430 which are configured to interact with or engage containers 240 (not shown in FIG. 7 or 8) within spiral packaging system 400 when the containers 240 are adjacent or proximate to the wheel 410.

FIG. 8 is an exploded view of the spiral packaging system 400 of FIG. 7 shown with the compliance wheel 410 omitted for clarity. An opening 440 in the first shell portion 110 is structured and configured to receive and support compliance wheel 410 in a rotatable manner. A ratchet slot or opening 450 is configured to allow the teeth 430 of compliance wheel 410 access to the interior of the spiral packaging system 400, thus allowing the compliance wheel teeth 430 to interact with pill containers 240 (not shown) when the apparatus 400 is filled with a chain of containers. The ratchet opening 450 is located proximate to the end portion of spiral track 140 of first shell portion 110, and proximate to container opening 230. The user may then detach and remove the container 240 that passes through opening 230 to access the medication contained therein.

For operation of the apparatus 400, a user manually rotates compliance wheel 410. The teeth 430 of the wheel 410 fit through slot 450 and engage the container 240 (FIG. 7) adjacent to slot 450, such that interaction of teeth 430 with container 240 during rotation of wheel 410 advance container 240 towards opening 230. After container 240 passes through opening 230, the user may detach the container 240 and access the medication therein as described above. Further rotation of wheel advances the next container 240 towards opening 230.

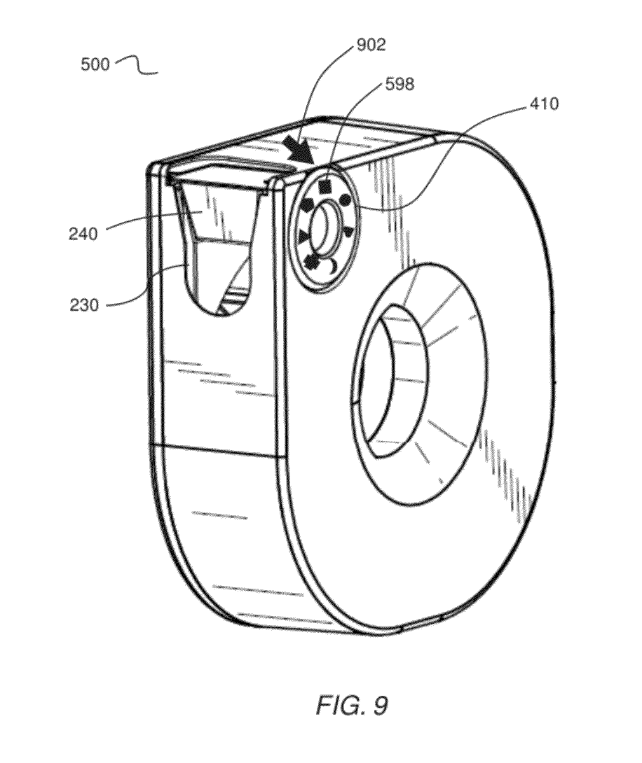

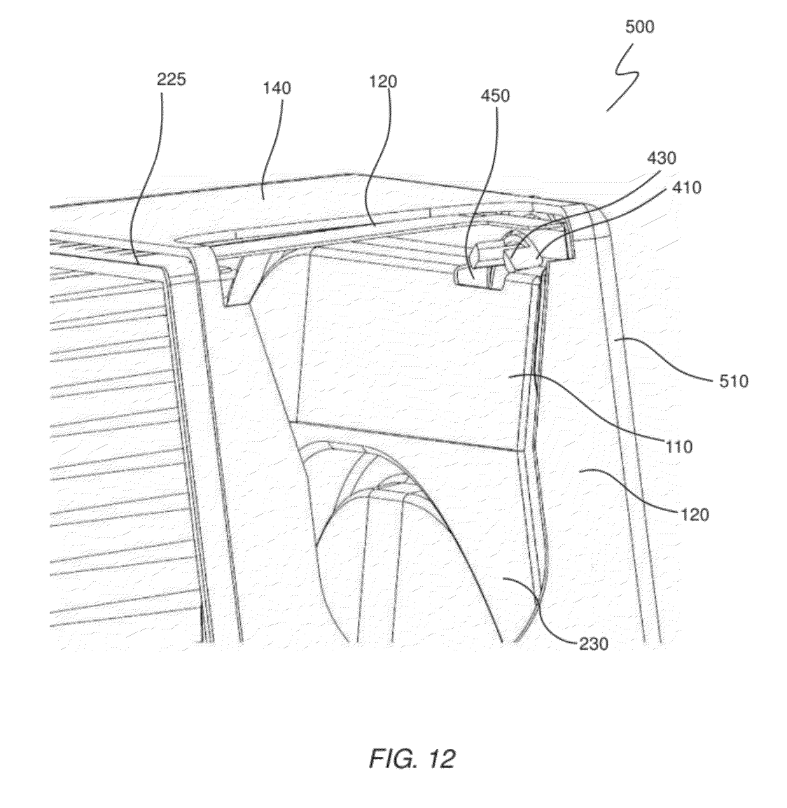

Referring now to FIGS. 9 through 12, there is shown another embodiment of a medication packaging system 500 wherein like reference numbers denote like parts. The apparatus 500 includes first and second opposing facings or housing elements 510, 530. Housing element 510 includes a central opening 540, a circular flange 550 surrounding opening 540, and a tapered region 560 surrounding flange 550. Housing element 510 also includes an opening 565 structured and configured to rotatably accommodate compliance wheel 410. Housing element 530 includes a central opening 570, a flange 580 surrounding the opening 570, and a tapered region 590 surrounding flange 580. FIG. 12 shows sprocket teeth 430 of compliance wheel 410 extending through slot 450, as viewed through opening 230 in the apparatus 500.

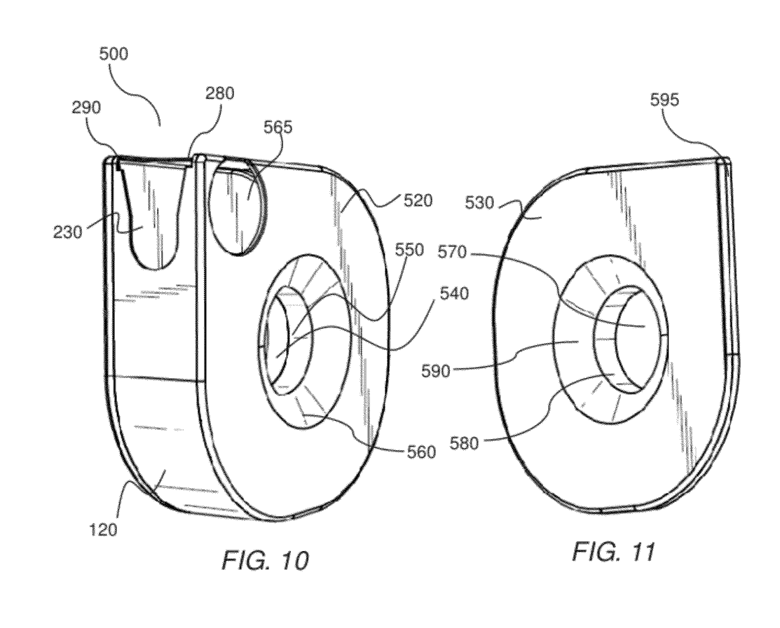

Housing elements 510, 530 are structured and configured to fit over first and second shell portions 110, 130 (FIGS. 7-8) respectively. Flanges 550, 580 thus are designed to fit over flanges 200, 210 of shell portions 110, 130, and tapered portions 560, 590 accommodate tracks 140, 150 of shell portions 110, 130 respectively. Housing elements 510, 530 include an outer flange 595 (FIG. 11) that is structured and configured to engage or otherwise interface with the outer lip 225 (FIGS. 7, 8) on shell portions 110, 130. As in the embodiment of FIGS. 4-6, housing elements 510, 530 provide flat, smooth, easily cleanable outer surfaces on the apparatus 300 that allows facile handling and is pleasing to users.

The compliance wheel 410 in FIG. 9 includes medical compliance tactile indicia or indicators 598 associated with medicament containers 240, with indicia 598 configured to verify the location of medicament containers with respect to aperture 230 and to verify whether or not a medicament container has already exited aperture 230 and has been removed from the apparatus. Tactile indicia 598 in this embodiment are temporal indicia and are shown as symbols each denoting a segment of time. For example, each tactile symbol may indicate a day of the week (e.g., a heart for Monday, an octagon for Tuesday, a square for Wednesday, etc.) which are located circumferentially around wheel 410. The position of tactile indicia 598 on wheel 410 correspond to the location of an associated or corresponding medicament container 240 within the apparatus 500 and provide an indication or verification for the user as to which medication container will next be dispensed through opening 230, and whether or not the medication container for a previous day or time period has already been removed from the apparatus 500.

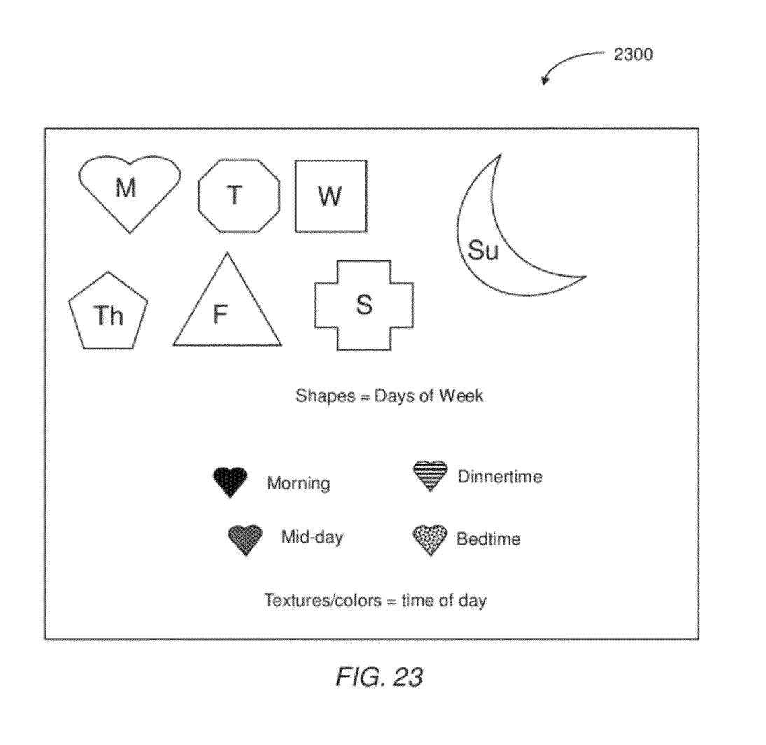

Thus, for example, when wheel 410 is rotated such that the “square” tactile indicia 598 is adjacent to arrow 902, the user will know that the container 240 positioned in or adjacent to opening 230 includes the medication for Wednesday. The user further will know that the corresponding medication container 240 for Tuesday (represented by “octagon”) has already been removed from the apparatus 500, and that the container 240 containing Thursday (“pentagon”) medication remains in the apparatus 500 behind the container 240 having the Wednesday (“square”) medication (see FIG. 23 for the “day key”). In this manner, the user can confirm or verify whether or not the appropriate medication for each particular day or other time period has been taken. In the embodiment of FIG. 9, counter clockwise rotation of wheel 410 advances containers 240 toward the opening. In the event that a user has advanced containers 240 too far, clockwise rotation of wheel 410 may retract or move the containers back into the apparatus 500.

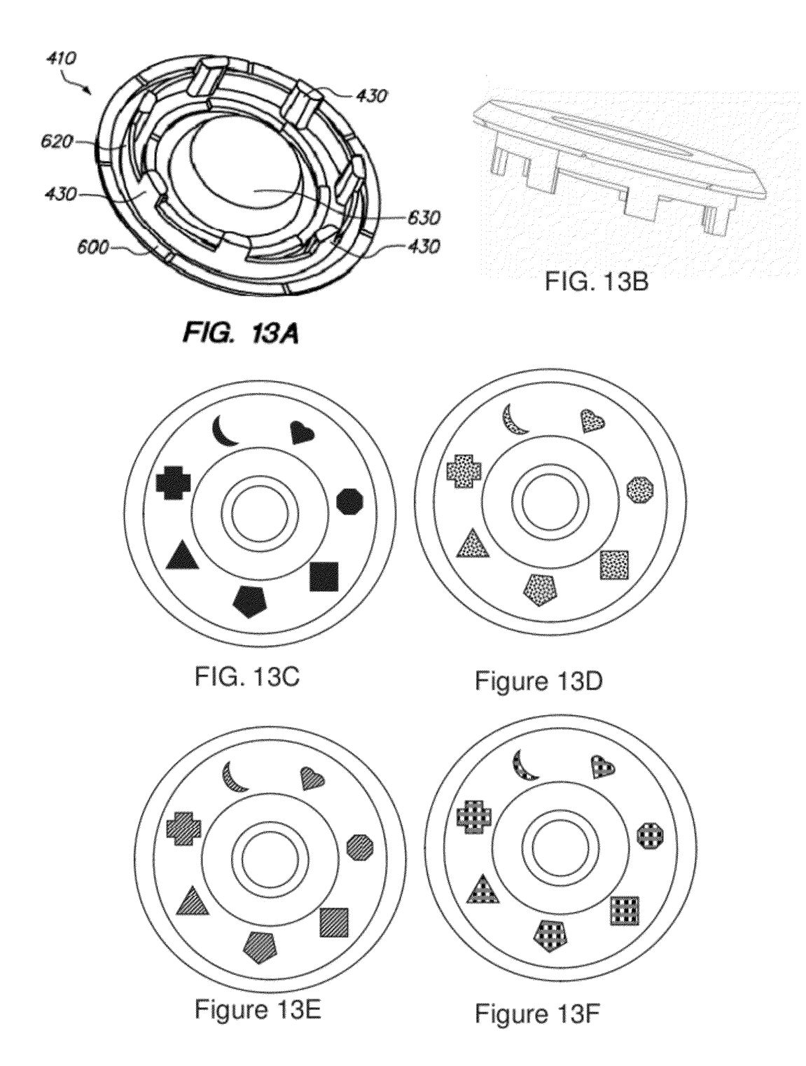

Referring to FIGS. 13A-13F, there is shown one embodiment of a compliance or drive wheel 410 in accordance with the tactile indicia described herein. FIG. 13A shows a first or inner side 600 of a compliance wheel 410 comprising a plurality of sprocket teeth 430 configured to interact with containers held within a medication dispensing system. The number of teeth 430 elements on the compliance wheel 410 may be varied according to the type of medical compliance needed and the configuration of medicament containers. If, for example, the compliance is to be a 7 day cycle, the compliance wheel 410 comprises seven sprocket teeth 430, one for each day of the week. The teeth 430 are spaced and configured to interact with one medicament container at time.

FIG. 13C shows a second or outer side 610 of the compliance wheel which includes tactile indicia 598 representing each day of the week. FIGS. 13D-13F show alternate textures for the tactile indicia symbols on the compliance wheel. Each texture corresponds to a different time period, allowing those with low vision to tell the containers apart without sight. The tactile indicia corresponding to the days of the week are aligned and configured with the sprocket teeth 430 on the compliance wheel 410 so that the user can determine if the medication for a particular day has been given, as described above. The number and positioning of sprocket teeth 430 on wheel 410 may be varied as required to accommodate different dosing requirements. The compliance wheel of the invention thus can provide for medical compliance with complex dosage regimens for patients.

The tactile indicia 598 on compliance wheel 410 may comprise various time indicia other than, or in addition to, the days of the week as shown. For example, tactile indicia 598 may include text, or symbols mapping to, “AM” and “PM” indicia, or “morning”, “afternoon” and “evening” indicia, or “B”, “L” and “D” for “breakfast”, “lunch” and “dinner”, depending on the particular dosing regimen needed for the patient user of the apparatus 500.

The compliance wheel 410 is shown in FIGS. 13A-13F as being structured and configured for use with the apparatus 500 of FIGS. 9-11. Wheel 410 thus comprises a circular flange 620 configured to fit within the compliance wheel opening 565 of the first side 510 of the housing of the spiral packaging system 500 shown in FIG. 9. Sprocket teeth 430 are positioned on flange 620. Wheel 410 further comprises a central indented portion 630 configured to facilitate manual rotation of wheel 410 by a user.

While the compliance wheel 410 is shown as being configured for manual operation, various other mechanisms for turning or advancing compliance wheel 410 may be used. For example, a spring-actuated mechanism operating according to force applied to a button, or a small battery-driven electric motor may be used to rotate wheel 410.

The compliance wheel 410 may be used with various medical packaging systems other then the spiral packaging system disclosed herein. Any tablet packaging system comprising a plurality of containers 240 arranged in a chain can utilize a compliance wheel to aid the user in determining when the last dosage was given and when the next dosage is needed, as well as to move or advance medication containers within a dispensing device. For example, a rectangular box comprising seven medicament containers 240, i.e. a weekly dose, could be used with the compliance wheel to determine if the current day's dosage had been given. The medicament containers 240 could be arranged in a linear, circular or snake-like alternating chain configuration. Use of a compliance wheel in accordance with the invention this provides for a variety of medication packaging systems with a dosage compliance feature.

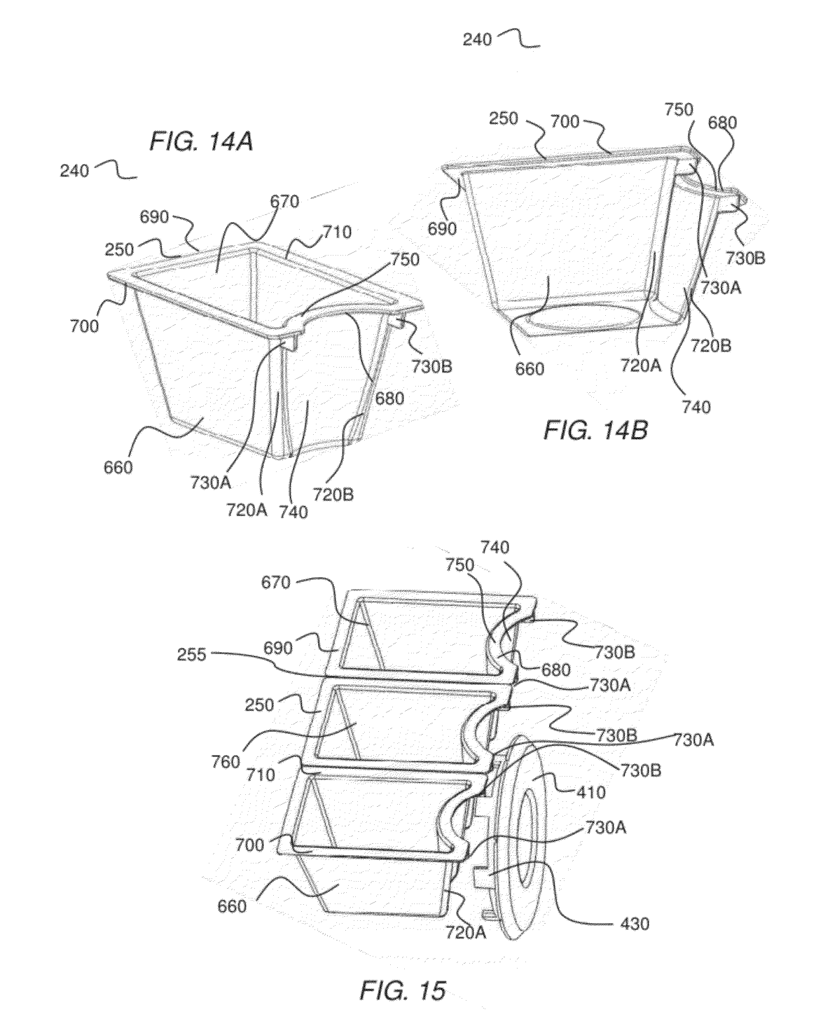

FIG. 14A, FIG. 14B and FIG. 15 show one embodiment of a medicament container or cup 240 for holding medication in the form of tablets, caplets, pills, capsules, powders, liquids, gels, suppositories or other form of medication. The medical container is configured to receive a tactile indication. The medication within containers 240 may be prescription medication, vitamins, supplements, herbal formulations, or combinations thereof, intended to be ingested by or administered to a patient to improve the patient's health or well being. The medicament container 240 comprises a tapered body 660 with a cavity 670 for holding a plurality of tablets or other medication. The container 240 includes a flanged top surface or edge 250 configured to be sealed with a lid (not shown). Container 240 may also include a frangible or removable top or lid (not shown) adjacent to flange 250. Breaking or removing the top allows a user to access the medication therein. The top may be transparent to allow a user to see the contents of container 240.

Generally, the flanged top edge 250 of container 240 comprises a first side 680 and second 690 side which are configured such that flange 250 interacts with the spiral grooves or tracks 140, 150 (FIGS. 1 and 2) of a packaging system such that container 240 can slide or otherwise move along tracks 140, 150. The flange top edge 250 further comprises a third side 700 and fourth side 710. When containers 240 are arranged in a chain, side 700 of one container 240 is positioned adjacent to side 710 of an adjacent container (except for the first container 240 in the chain). Top edge sides 700 and 710 of adjacent containers 240 can be connected to one another by a frangible interface 255. The containers 240 can then be detached from one another by breaking the connector 255.

Each container 240 includes protrusions or ribs 720A, 720B on the exterior of tapered body 660 of the container 240. Ribs 720A and 720B each support a tab section 730A and 730B respectively, with tabs 730A, 730B located adjacent top flange 250. The tabs 730A and 730B are configured to interact with sprocket teeth 430 (FIG. 14) on compliance wheel 410 to allow the container 240 to be moved as teeth 430 apply force to tabs 730A, 730B when wheel 410 is rotated. The ribs 720A and 720B and tabs 730A and 730B may in many embodiments be configured to aid in childproofing the packaging system, as described further below. Counter-clockwise rotation of wheel 410 results in teeth 430 applying force to tab 720A to move container 240 in one direction, while clockwise rotation of wheel 410 results in teeth 430 applying force to tab 720AB to move container 240 in the opposite direction.

The tapered body 660 of each container 240 further comprises an arcuate or concave portion 740 positioned between the ribs 720A and 720B. Top flange 250 includes an arcuate or concave portion adjacent to the concave portion 740 of container body 660. The configuration of the concave portions 740 and 750 of the container 240 allows the teeth 430 of compliance wheel 410 to engage the tab portions 730A, 730B of the container 240 without interference from the tapered body 660 of the container 240.

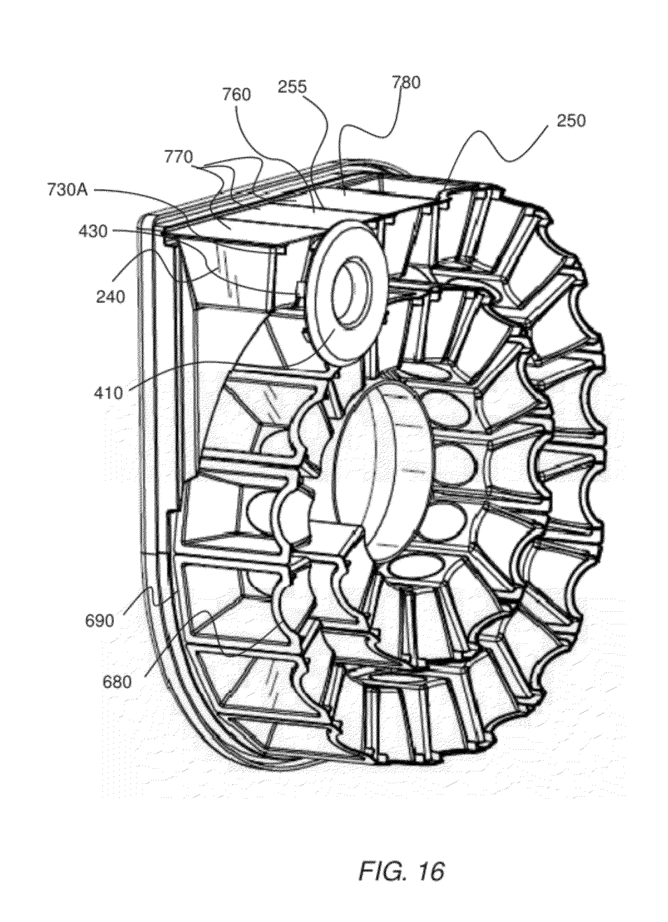

Referring now to FIG. 16, a plurality of medication containers 240 and a compliance wheel 410 are shown in association with the spiral track of shell portion 130 of a spiral packaging system (wall 120 and shell portion 110 are omitted for clarity). A flexible lidstock strip 760 provides a cover for the chain of containers 240, with the portion of lidstock strip 760 adjacent to a container providing a lid or cover 770 for that container. For clarity, lidstock strip 760 is shown only on the first three containers 240, but it should be understood that lidstock strip 760 extends to cover each of the containers in FIG. 16. The top edge sides 700 and 710 of adjacent containers 240 are joined together by the lidstock strip 760, which seals each container 240 and joins adjacent containers 240 together.

The lidstock strip 760 may be frangible or breakable at the interface or junction of sides 700, 710 to allow detachment and separation of adjacent containers 240. The lidstock strip 760 may include perforation lines (not shown at edges 700 and 710) to provide frangible interfaces 255. The lidstock strip 760 is configured to receive tactile indicia. When thus detached, each container 240 retains a portion 770 of the lidstock strip 760 as a cover, which can be removed or broken to access the medication within the container 240.

A plurality of containers 240 may be connected to one another by a single lidstock strip 760, allowing a “chain” of containers to be easily filled, sealed and placed in the spiral groove or track of a packaging system. Each sealed container 240 may be assigned to a specific dosage period and contain the medicines required for that dosage period. In addition to the tactile indicia and/or color indicia, the section of lidstock strip 760 adjacent to each container 240 may be printed (using thermal transfer, ink jet, laser, or other suitable electronic printing method) with patient, medicine, and dosage period information, such as patient name; D.O.B.; dosage period; date; medicine contained including type, strength, number of tablets; expiry date, and the like.

Lidstock strip 760 provides a writing surface 780 where patient data, container content and prescription information can be placed. The lidstock strip 760 may be extended between adjacent sealed containers (and then folded up as it is loaded into the dispenser or packaging system) to allow for extra writing surface print area and a larger gripping surface for removing lids 770 from containers 240. The sealed container strip or chain is designed to be filled using a valid table automated filling system that can include automatic inspection and verification of the medication product with which containers 240 are filled.

The lidstock strip 760 is configured to attach or adhere to the flanged top surface 250 of each of the individual containers 240. Lidstock strip 760 is preferably a laminated film which is heat sealed onto the flanged tops 250 of containers 240. Lidstock strip 760 may further comprise peel tabs (not shown) which extend out past the flanged top edge 250, making the lid 770 of each container 240 removable by peeling to facilitate in the opening of the container 240. Concave portions 740 and 750 facilitate removal of lid 770 from container 240 by a user by providing a “finger groove” to allow grasping of the lid 770 (it may also include a separable plastic gripping tab and/or a feature to enable it to be connected to the dispenser body for one-handed opening). Lid 770 also comprises a writing surface 780 where patient data, container content and prescription information can be placed.

The individual containers 240 are preferably manufactured from clear or tinted plastic to allow viewing of the tablets within. The individual container(s) may be made by thermoforming or injection molding techniques. Exemplary plastics utilized for the individual container comprise but are not limited to polyphenysulphone, polystyrene, polypropylene, as well as polyethylene. The lidstock strip may comprise a paper-backed plastic film or foil laminate with sealing material in the structure for a peel seal with the molded plastic sealed flanged cup body.

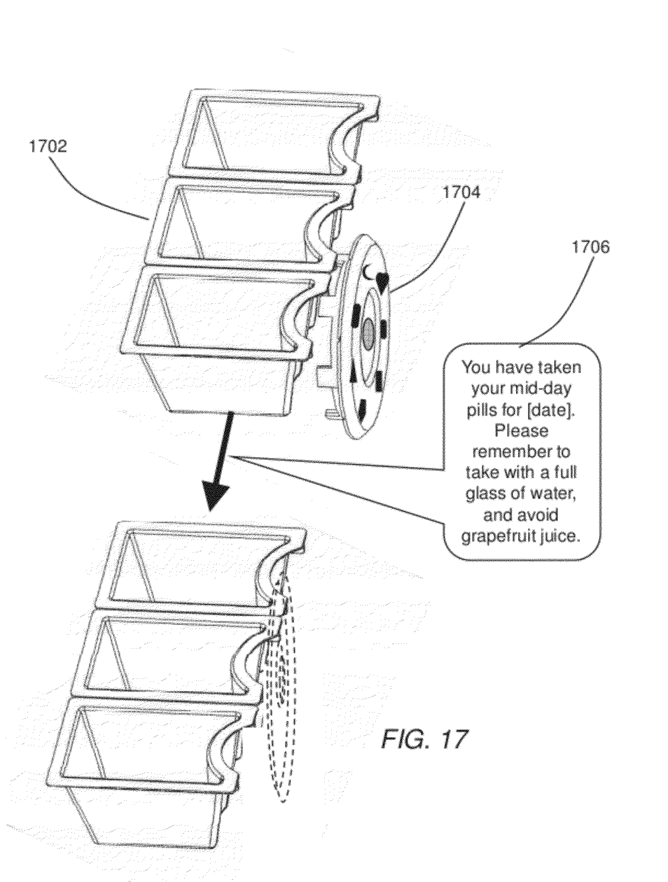

Referring now to FIG. 17, there is shown a partial strip of medicament cups 1702 in articulation with the compliance wheel. In this embodiment, actuation of the compliance wheel 1704 will activate audio compliance indicia (e.g. message 1706). The audio associated with the compliance wheel may be actuated by rotating the compliance wheel counter-clockwise (advancing the wheel) or by rotating the wheel counter-clockwise. In some embodiments, the audio associated with the compliance wheel may be activated by activating a switch, for example, by depressing the compliance wheel relative to the apparatus. In yet another embodiment, the audio may be activated when a container is removed from the dispenser. The audio may be initiated mechanically in response to the movement of the teeth on the compliance wheel. The audio compliance indicia may include dosage information, precaution information, or a combination thereof. For example, when the compliance wheel is advanced, an audio message may be initiated, such as, “You have taken your mid-day tablets for [date]. Please remember to take with a full glass of water, and avoid grapefruit juice.”

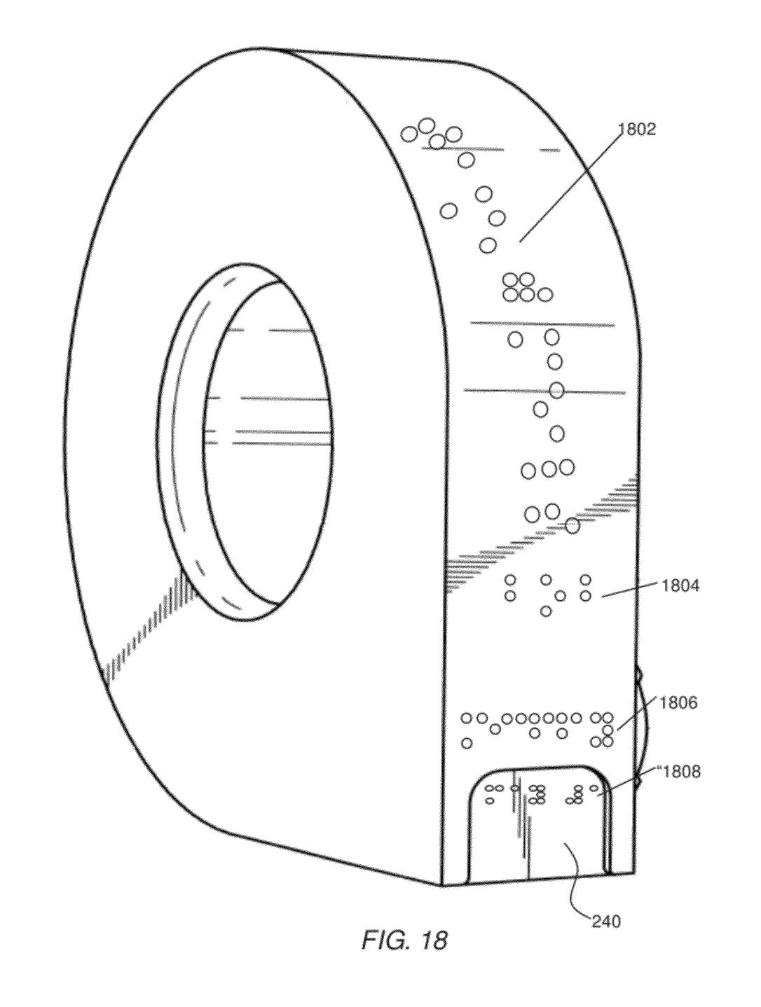

Referring now to FIG. 18, there is shown another embodiment of a spiral packaging system in accordance with the invention. The apparatus includes transparent outer facings or housing elements that are joined to shell portions as described above for the apparatus in FIGS. 4-6. In this illustrative embodiment, tactile indicia, including precautions, the name of the patient, the time period for tablet consumption, and the date are encoded in Braille. For example, apparatus may have Braille indicia such as the messages shown in FIG. 18, in which Braille messages 1802, 1804 and 1806 indicate, “Take with meals,” a patient name “Bob,” a tablet consumption time “Mid-Day,” respectively. Additionally, container 240 is marked with a Braille indication 1808 of the date the tablets within the container are to be consumed. This type of package is suitable for individuals who have become fluent in Braille. However, Braille indicia may not work for the many patients who are blind or have low vision, but have not learned Braille.

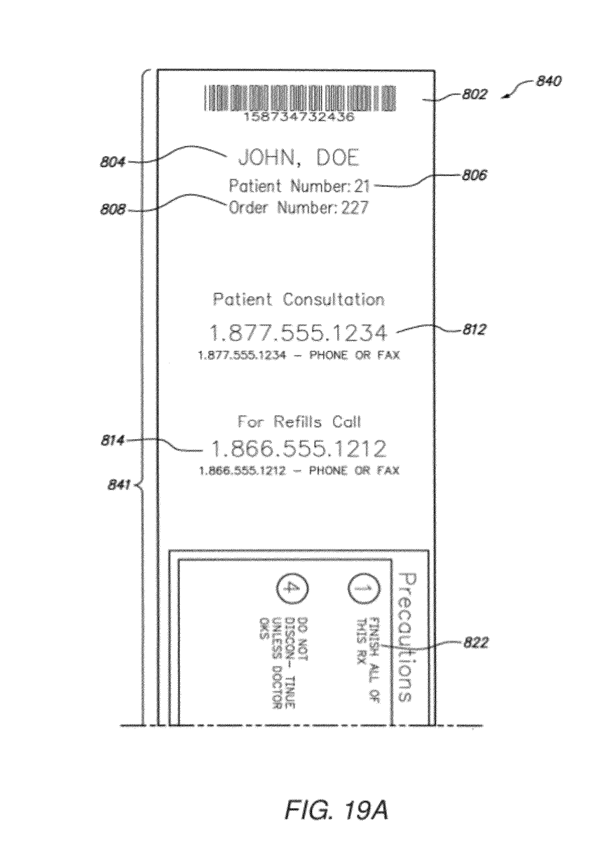

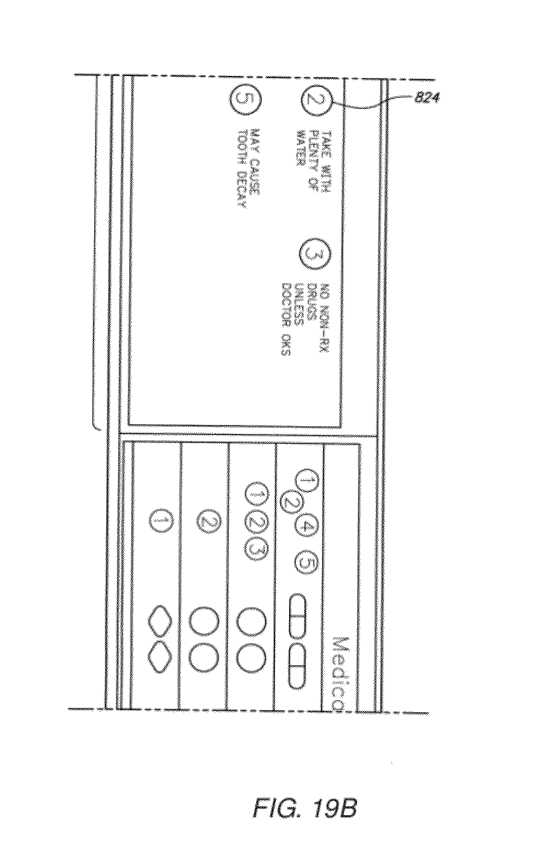

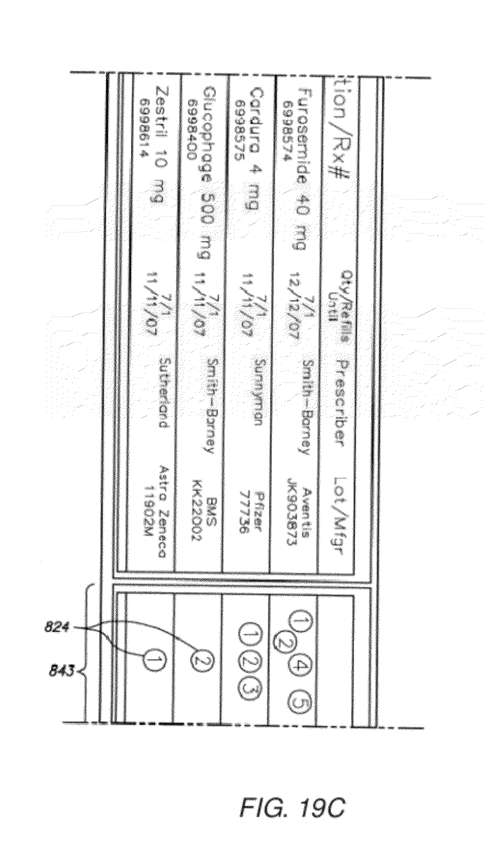

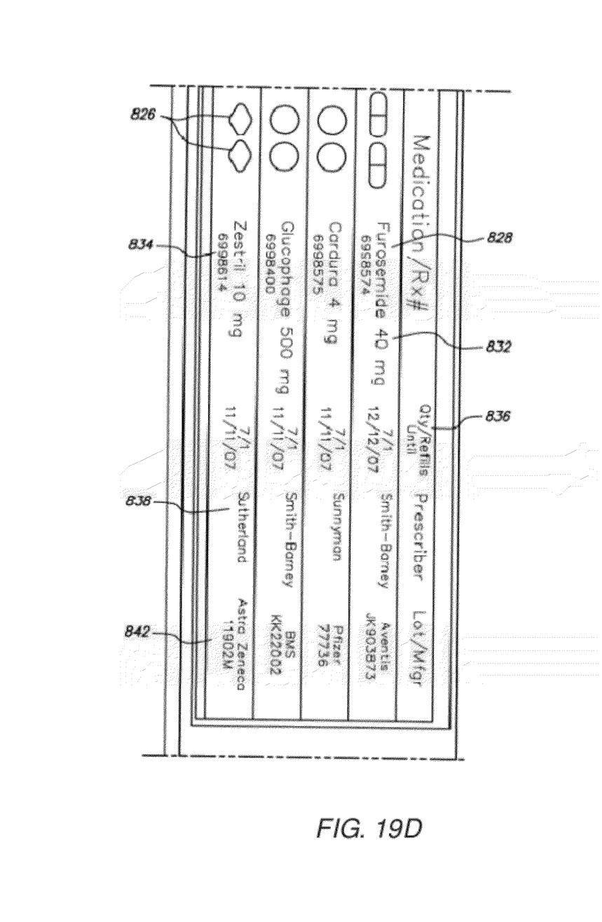

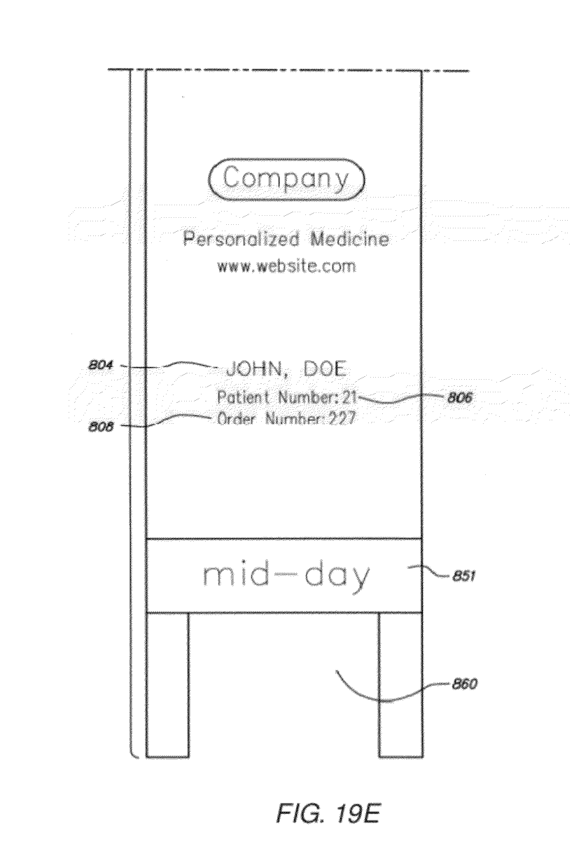

Referring to FIGS. 19A-E, a label strip 840 is structure and configured to fit within the apparatus 800 along the transparent outer wall 120. Label strip 840 includes patient and medication data such as, for example, patient name and number, names of relevant physicians, medicine(s), dosage strength(s), medicine quantity(s), color images of the medicine(s), prescription number(s), NDA number(s), warning(s), dosage period(s), administration schedule(s), and the like. In embodiments wherein the apparatus 800 is reusable, label strip 840 may be interchangeable and removable from the apparatus 800 when disassembled. In embodiments where the apparatus 800 is disposable after each use, the label strip 840 may be adhered directly to the inner or outer surface of wall 120. An opening 860 at the end of strip 840 conforms in shape to opening 230 so that opening 230 is not blocked by strip 840. While this detailed label includes much useful information for the sighted, it is of little use to a patient who is blind or has low vision. It is desirable to include as much information as possible from the label for sighted individuals in the low-vision adaptive indicia. The label strip 840 is also configured to receive tactile and color indicia.

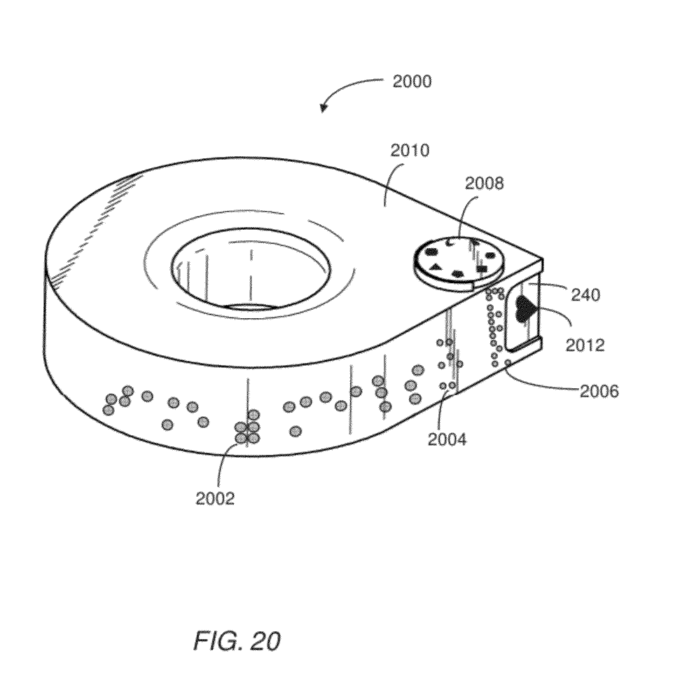

Referring now to FIG. 20, another embodiment of a low-vision adaptive spiral package is shown. This embodiment 2000 shows one combination of Braille indicia and an alternate audio compliance actuator. Braille text 2002 reads “Take with Meals.” This phrase corresponds to a drug precaution that can be associated with a particular tablet in a multiple medication regimen. Braille text 2004 is the name of the patient; in this case, it reads “Bob.” Note, the patient's full name does not need to appear in Braille. Braille text 2006 refers to the particular time period that the tablets are supposed to be consumed, in this case, “Mid-day.” The container may additionally have Braille or symbolic indicia of the time period associated with the tablets contained and additional precautionary information associated with the tablets. The audio compliance indicator is actuated when compliance wheel 2008 is depressed relative to dispenser 2010. Symbol 2012 located on container 240 is an illustrative compliance indicator providing an indication to the patient of, for example, the day of the week on which the tablets within the container are to be consumed.

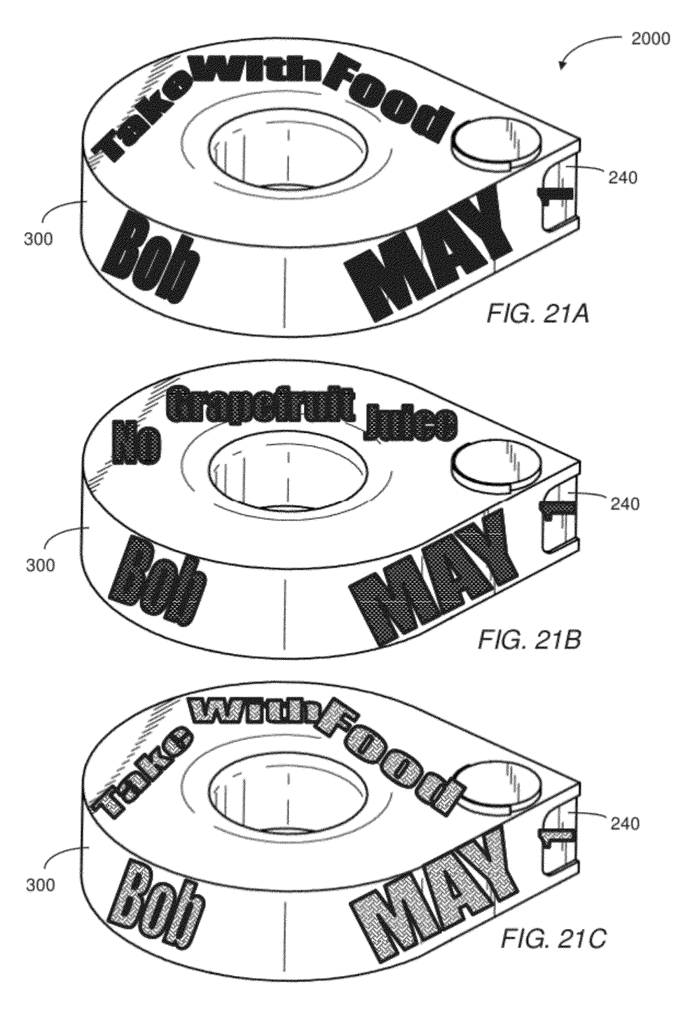

Referring now to FIGS. 21A-21C, there is shown a set of low-vision adapted spiral medication packages. In the exemplary embodiment shown, the packages indicated at 21A, 21B and 21C contain tablets to be consumed in the morning, at noon, and in the evening, respectively. In this embodiment, the precautions appear in enlarged text that is configured to be used by those with low vision. The enlarged text on dispensers 230 and containers 240 are shown with a variety of fill or hatching patterns which may represent a variety of colors, hatching or cross-hatching patterns. The illustrative colors represented by the fill patterns are red, represented by the solid fill in FIG. 21A; orange, represented by the crosshatched fill in FIG. 21B; and yellow, represented by the tiled fill in FIG. 21C. The different fill patterns may also represent a tactile indicia or tactile texture. The illustrative textures or tactile surface are represented by the solid fill in FIG. 21A, the crosshatched fill in FIG. 21B; and the tiled fill in FIG. 21C. In the illustrative embodiment, the texture textures and colors are paired such that each time period is represented by both a color and a textile texture, giving those with low vision more than one cue to use to interpret the text.

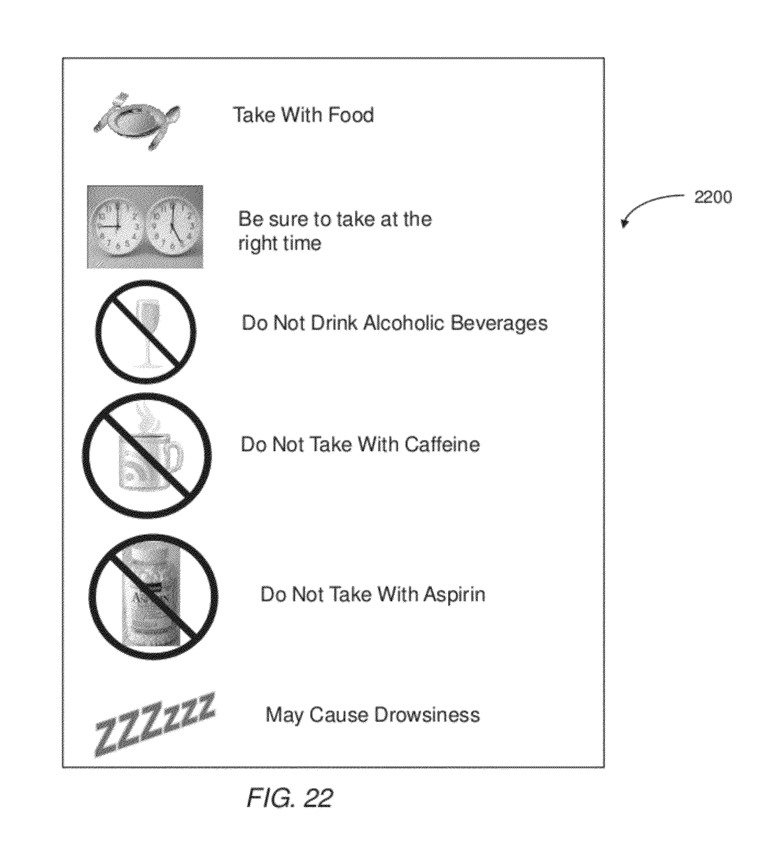

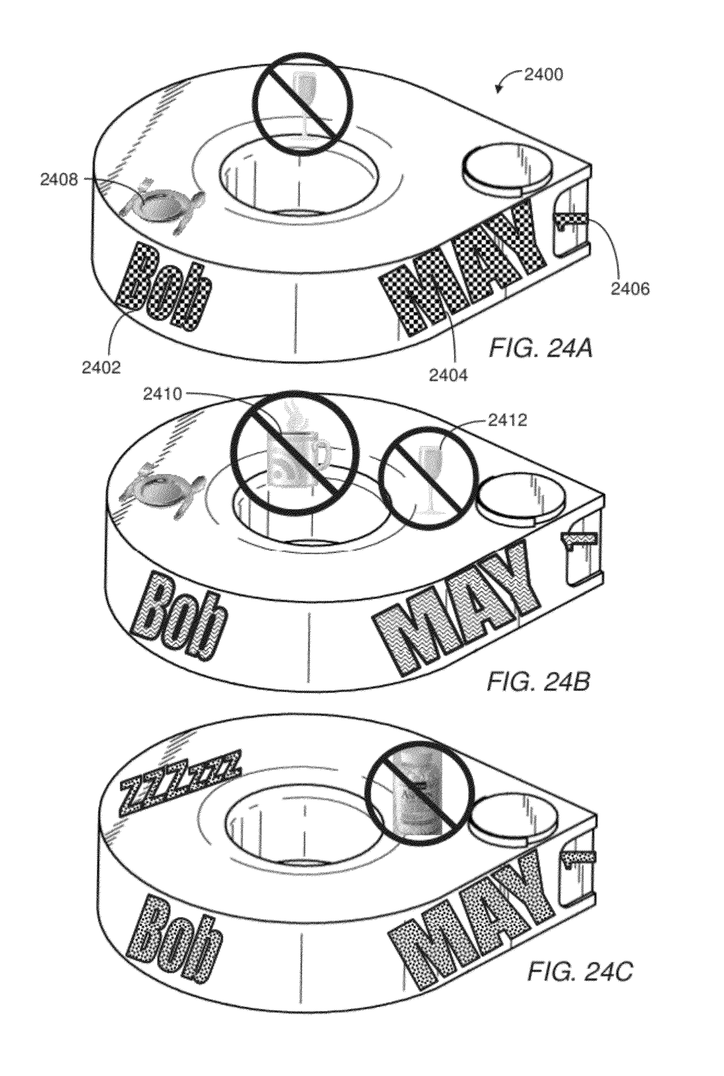

Referring now to FIG. 22, there is shown in legend 2200 an illustrative list of symbols that may be used to convey drug precaution information to those with low vision. The symbols shown in FIG. 22 may appear on the medication dispensers as shown at FIGS. 24A-24C and include a tactile symbolic representation.

Referring now to FIG. 23, there is shown in legend 2300 an illustrative list of tactile symbols that may be used to convey the day of the week and the time that the tablets should be taken to those with low vision. The tactile symbols shown in FIG. 22 may appear on the medication dispenser, compliance wheel, tablet container, pouch or another such preliminary package or final package.

Referring now to FIGS. 24A-24C, there is shown a set of low-vision adapted spiral medication packages 2400. In this embodiment, the name of the patient 2402, the month that the tablets should be taken 2404, and the day of the month that the tablets should be taken 2406 all appear in enlarged text that is configured to be used by those with low vision. The different fill patterns represent colors. The illustrative colors represented by the fill patterns are red, represented by the solid fill in FIG. 21A; orange, represented by the crosshatched fill in FIG. 21B; and yellow, represented by the tiled fill in FIG. 21C. The precautions information is denoted by symbols (see FIG. 22) that are configured to be used by those with low vision. The illustrative symbol 2408 that resembles a dinner plate means to take the medication with food. Illustrative symbol 2410 indicates that the medication should not be taken with caffeine, and illustrative symbol 2412 indicates that the medication should not be taken with alcohol.

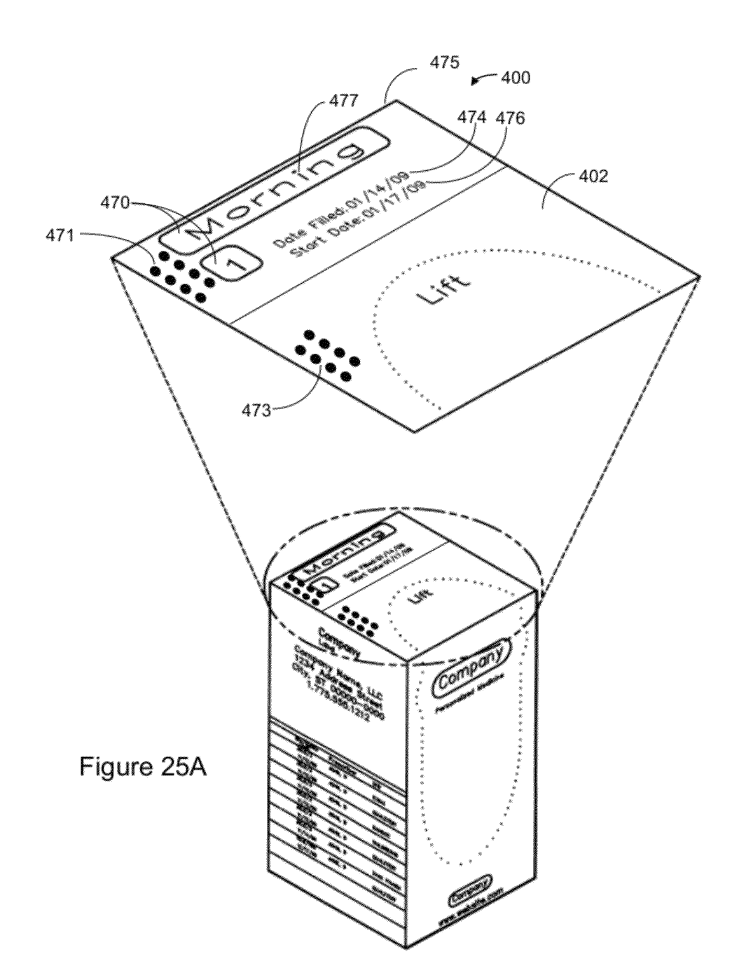

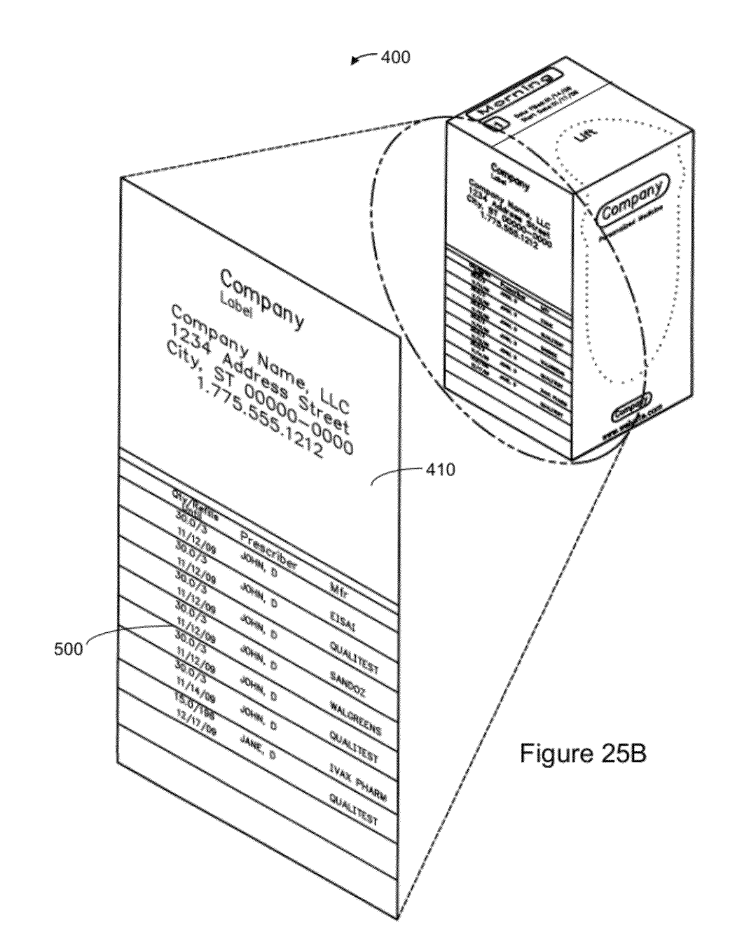

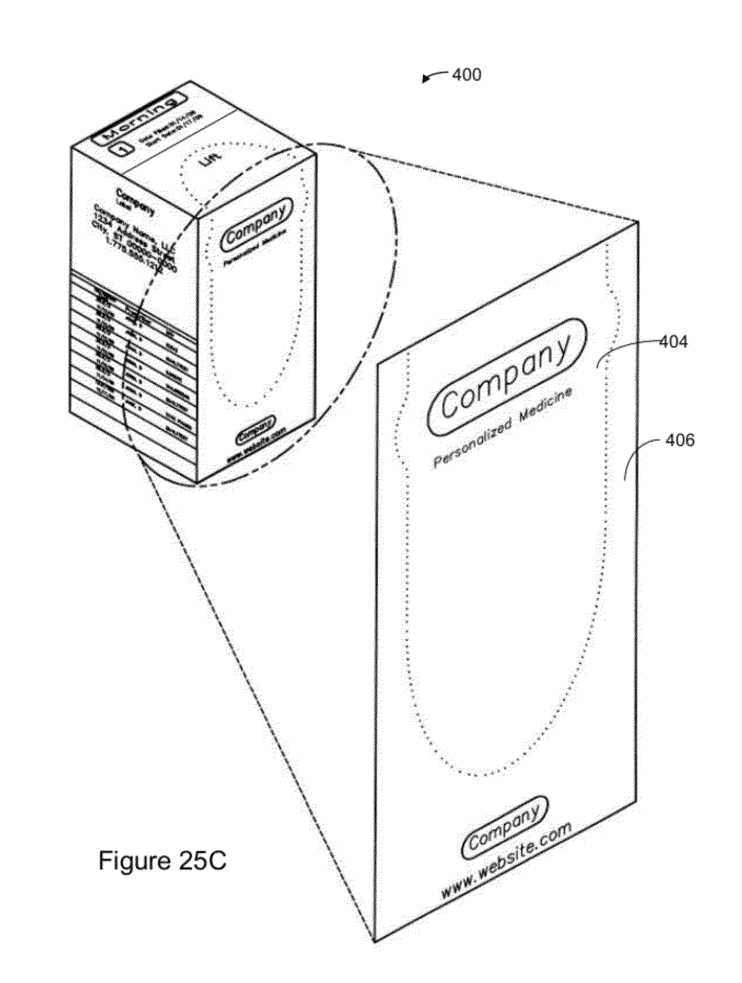

Referring to FIGS. 25A-25C, there are shown isometric views of the 30-day tablet dispensing container 400. In general, the illustrative 30-day tablet dispensing container is a foldable box that includes a top wall, a front side wall, a right-side wall, a back side wall, a left-side wall and a bottom wall. The top wall has one end fixedly coupled to the foldable box and an opposite end that provides a foldable lid. The front side wall has a removable lid that is bordered by a plurality of perforations. The right-side wall abuts the front side wall and the top wall. The back side wall abuts the right-side wall and the top wall. The left-side wall abuts the top wall and is between the back side wall and the front side wall. The bottom wall abuts the front side-wall, the right-side wall, the back side, and the left-side wall. The container is formed to receive a plurality of pouches as described herein.

By way of example and not of limitation, the illustrative cardboard used to construct container 400 includes an outer smooth layer of paper and a thick interior layer. The outer smooth layer may receive printed text or images using an illustrative laser printer, ink jet printer or other such printing means. Additionally, the outer layer may also be configured to receive a label that is affixed thereto.

In the illustrative embodiment, a perforated, removable lid 404 makes up a large portion of the front side wall 406 and top wall 402 of the illustrative container 400. The lid can be partially or completely removed in order to access the medicament pouches within the container 400. In one embodiment the lid 404 may only occupy one wall such as the front side wall. In the illustrative embodiment, the lid occupies the front side wall 406 and extends to the top wall 402.

The illustrative top wall 402 has one end fixedly coupled to the foldable box and an opposite end that provides a foldable lid. A secondary label 475 is configured to seal the foldable lid on the top wall. In the illustrative embodiment, the secondary label has a bar code (shown in FIG. 19A) and includes the time interval when the tablets should be administered or taken. In the illustrative embodiment, the secondary label 475 visible on top wall 402 of the container 400 indicates the time period 470, the filling date 474, and the prescription start date 476 listed above the perforations of lid 404. Additionally, an illustrative tactile indicia (Braille) 471 and 473 are shown on the final package.

A portion of the primary label 500 is visible in FIGS. 25A-C, shown affixed to the container 400 such that it covers the lower portion of the left side wall of the container 400. The label goes on to cover the lower portion of the back side wall and right-side wall of the container 400. In the view shown in FIGS. 25A-C, the top wall 402, front wall 406 and left side wall 410 of container 400 are visible. The label includes important information related to the prescriptions and to the individual patient for whom the medications were prescribed.

The illustrative primary label 500 may include, for example, patient and medication data such as patient name and number, names of prescribing physicians, medicine(s), dosage strength(s), medicine quantity(s), color images of the medicine(s), prescription number(s), NDA number(s), warning(s), dosage period(s), administration schedule(s) and the like. The illustrative label strip is configured such that all information necessary for drug identification and administration is affixed to the container 400.

The illustrative container 400 comprises a cavity defined by the front side wall, the right-side wall, the back side wall, the left-side wall and the bottom wall, wherein the cavity is configured to receive the plurality of filled pouches that are associated with a bar code. The plurality of filled pouches includes at least 28 filled pouches, in which each pouch comprises a plurality of different tablets associated with a prescription. The barcode is associated with at least one of the pouches, wherein the barcode is associated with the prescription.

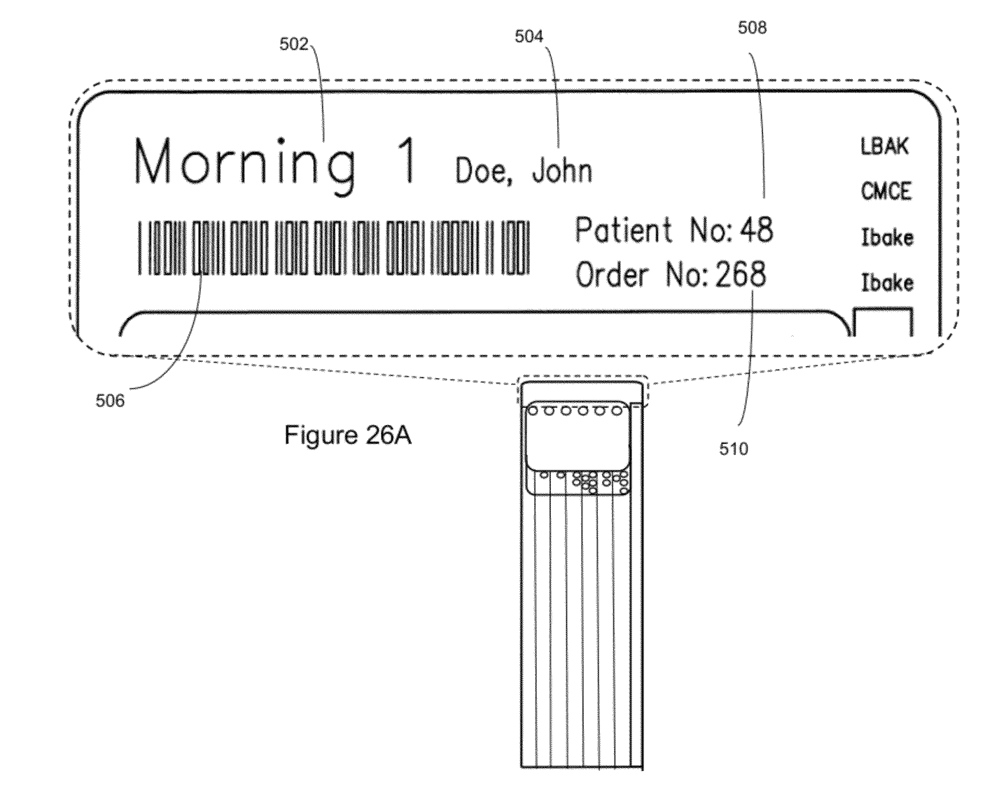

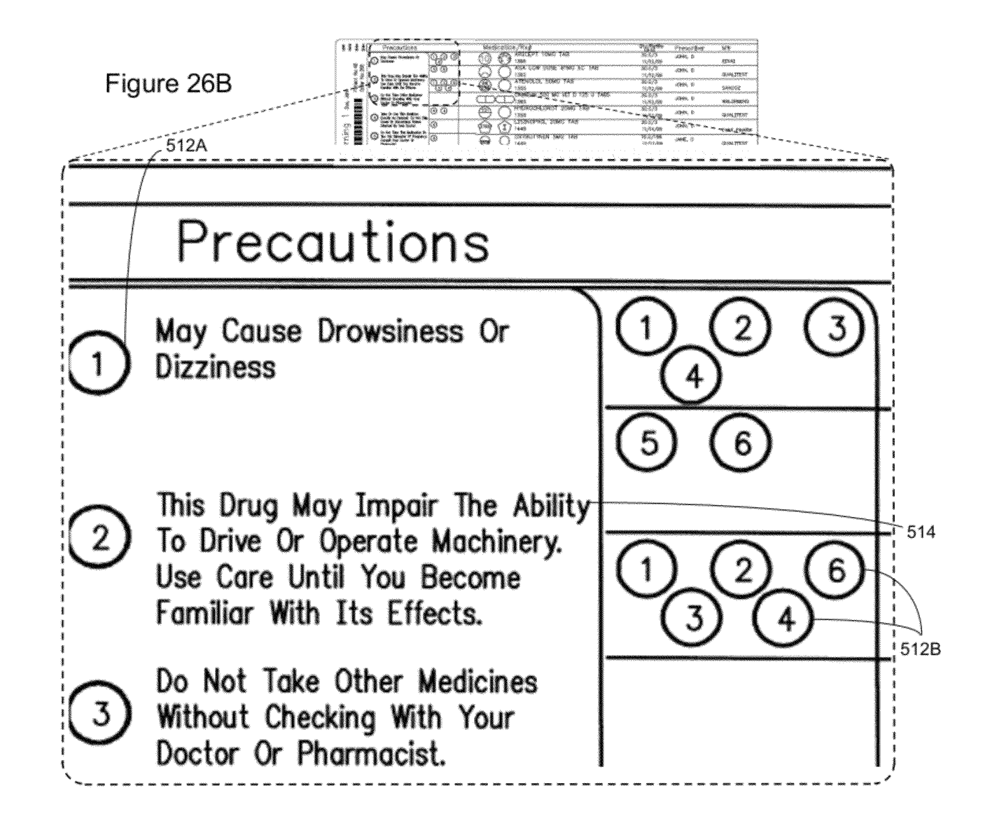

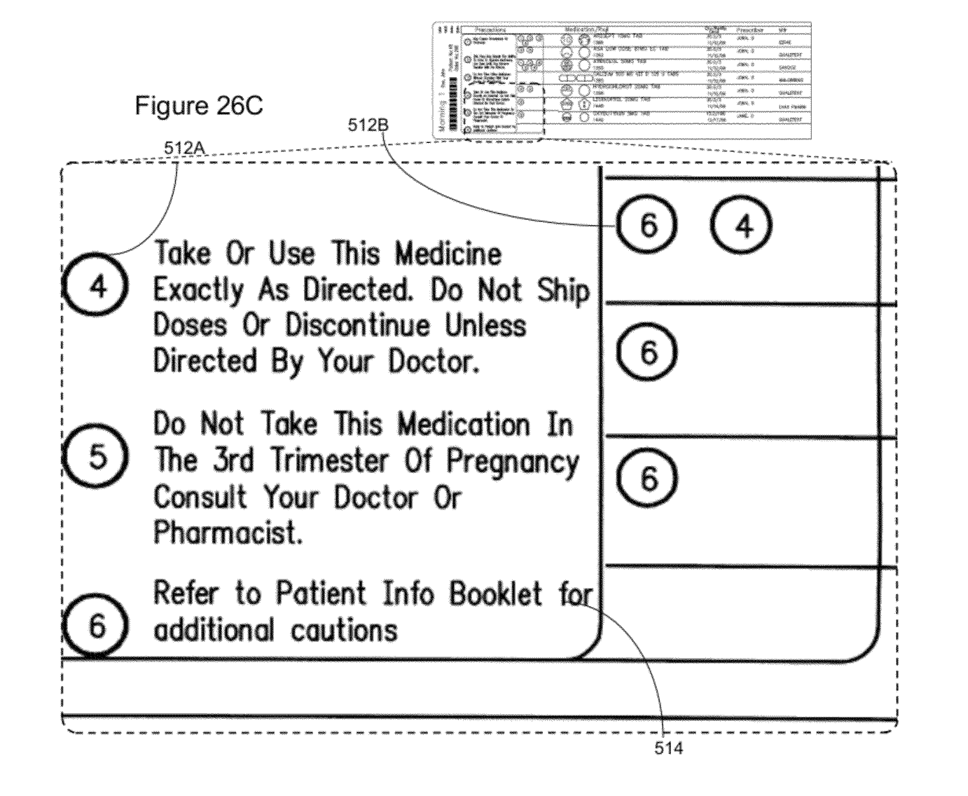

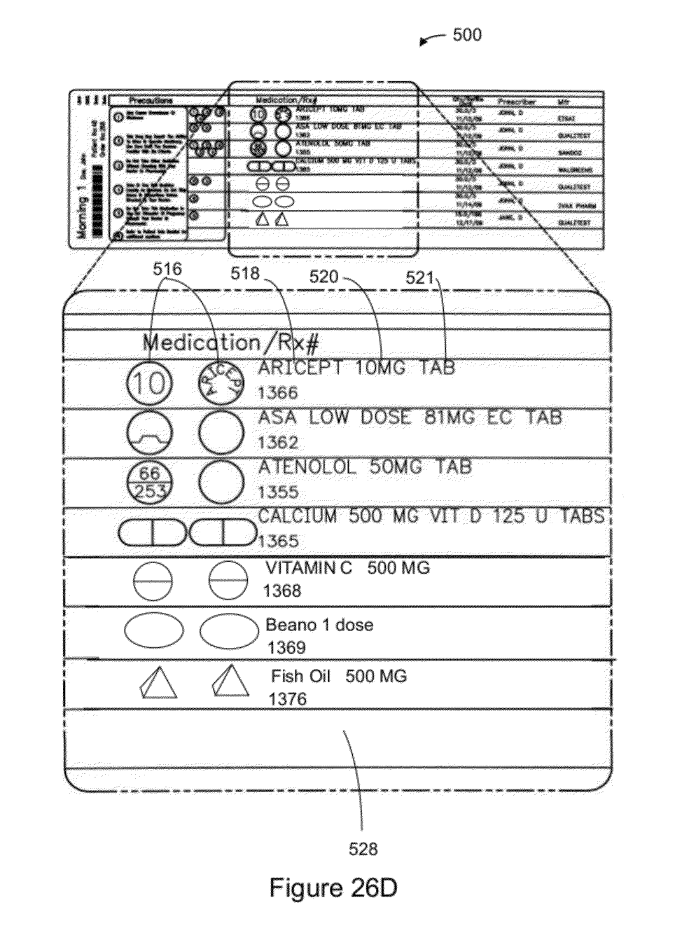

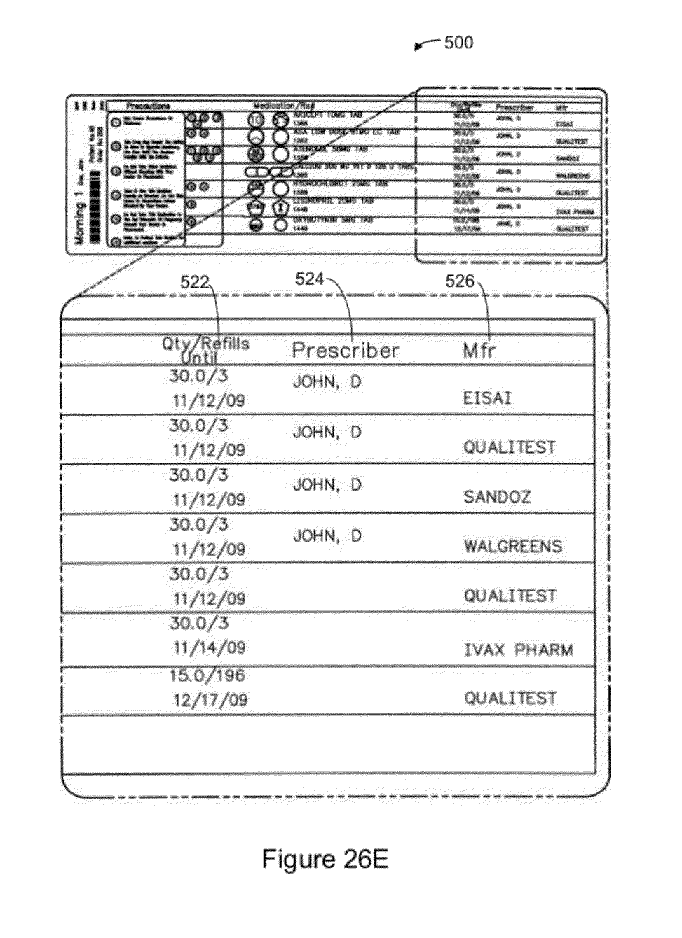

Referring to FIGS. 26A-26E there is shown an illustrative primary label 500. The primary label 500 is the large label that is affixed to the side walls. The secondary label 475 is affixed between the top wall and the back side wall. The primary label 500 is affixed to the foldable box and includes a description of the medications and the barcode associated with the prescriptions.

The illustrative bar code provides a means for associating the labels and pouches with a particular patient. By way of example and not of limitation, the means for associating the pouches may also include a radio-frequency identification (RFID) component, writing or other such associative element capable of associating the labels, pouches and particular package with a particular patient

Starting from the left side of FIG. 26A, the label includes patient and dosage period information including time period 502, patient name 504, barcode 506, patient number 508, and order number 510. Some embodiments, particularly those embodiments suitable for use in a long-term care facility, may also include a photograph (not shown) of the patient in this portion of the label with other identifying information. In other illustrative embodiments, the label may include information about a variety of different prescriptions and medications associated with each of these different prescriptions. Furthermore, the primary label may include an expiration date for each prescription.

The time period 502 refers to the particular time of day that the patient must take the tablets within the container. In this illustrative label, the time period is “Morning.” The numeral “1” next to the word “Morning” is another reference to the time period. In this case “Morning” is the first time period during which the illustrative patient must take medications.

A barcode 506 is printed on the illustrative label 500. A barcode may appear on each element of the container and its packaging including the illustrative label 500, the container 400 as shown in FIGS. 25A-25C and an illustrative strip of packets or pouches configured to be placed within container 400. The barcodes may encode important information such as time period 502, Patient Name 504, Patient Number 508 and/or Order Number 510. The barcodes are associated with one another during container assembly and filling, improving order verification by ensuring that the appropriate pouches, having been filled with medicaments associated with a particular patient 504 and time period 502, are placed in the appropriate container 400 that is associated with the particular patient 504 and time period 502. Barcodes are also used to ensure that the appropriate label 500 is affixed to the appropriate container 400 associated with a particular patient 504 and time period 502. The barcode may also be associated with a variety of different prescriptions and the corresponding expiration date for each prescription.

Referring now to the “Precautions” section of the illustrative label 500, there is shown a list of drug precautions 514 associated with the medicaments in the illustrative order. Each drug precaution for each drug found within the container is present in the Precautions section. The Precautions section may also include information on synergistic, agonist or antagonist effects that may occur among one or more medications in the order. Each precaution 514 is associated with a numeral 512A, or with another easy-to interpret symbol. Each precaution applies to at least one drug in the order, but may apply to more than one drug.

The next column of label 500 contains another set of numerals 512B that map to the numerals 512A and thus to drug precautions 514. For example, one of the drug precautions 514 instructs patients to refer to the Patient Info Booklet for additional cautions. The 512A number “6” is associated with the Patient Info Booklet precaution. In turn, the 512B number “6” is associated with several of the prescription tablets 518. Other easily interpreted symbols could be used in place of numbers, but it is essential that the first set 512A maps exactly to the second set 512B.

Referring now to FIGS. 26C and 26D, the next part of the label 500 shows drug information, including color images 516 of each drug in the order and the name 518 of each drug in the order. The numbers 512B are grouped such that each ‘cell’ containing a group of numbers 512B is associated with exactly one drug 518. The numbers 512B show which listed precautions are associated with each prescription in the order. As shown, each precaution 514 maps to exactly one number 512A, but each precaution 514 and its corresponding number 512B may apply to more than one drug in an order. That is, each number found in the set of numbers 512A may appear associated with any or all drugs 518 in the order, depending on which group of numbers 512B appears next to the drug image 516 and name 518.

For example, on the illustrative label 500, six precautions 514 are shown, each of which is in turn associated with exactly one number 512A. The first drug 518 listed on the label is “ARICEPT.” Next to the word “ARICEPT” is shown the color image of the drug 516, and on the other side the 512B numbers “1, 2, 3, & 4” are listed. This means that each precaution 514 associated with each of the 512A numbers “1”, “2”, “3”, and “4” applies to “ARICEPT.” Further, the number “4” appears in the groups of numbers 512B adjacent to three of the six illustrative drugs, and number “6” appears in the groups of numbers 512B adjacent to five of the six drugs listed, while the 512B number “5” is listed next to only one drug. This means that the precaution 514 associated with 512A number “5” applies only to one drug, while the precaution 514 associated with 512A number “6” applies to almost every drug in the order.

The “Medication/Rx#” section of FIG. 26D includes the drug images 516 and the drug name 518 mentioned above, in addition to the unit dosage 520, the drug format 521 and the prescription number 528. Thus, a variety of different prescriptions may be consolidated and integrated into the primary label 500. The prescriptions may also include different expiration dates as indicated by the dates in column 522, shown in FIG. 26E. The color images 516 show both the front and the back of each tablet. The color images allow the patient or a caregiver to identify individual medications within each pouch by using the label 500 as a key. If a patient's medication must be changed in the middle of a 30-day prescription order, this allows the patient to keep taking medications from the current 30-day period by merely discarding tablets associated with any discontinued prescriptions or recommendations after opening the packet or pouch, and consuming the remaining medications.

The next column of text, shown in FIG. 26E, displays refill information 522 including the number of refills left on the prescription for that drug, the quantity of tablets that is supplied each time the prescription is filled and the date that the prescription expired. The next column of text includes the prescribing practitioner's name 524 for each drug 518 and the last column includes manufacturer information 526 including the name of the manufacturer or other manufacturer data.

The tactile indication associated with the prescribed time of day for consuming the tablets may be located on the preliminary package, the final package or the combination thereof.

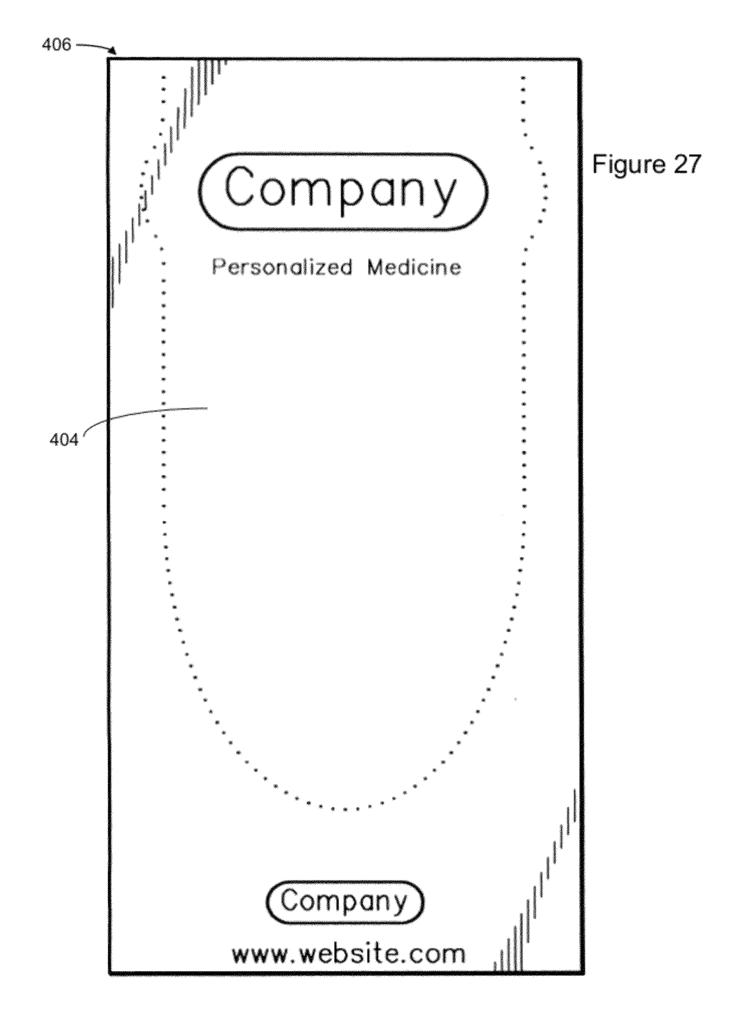

Referring to FIG. 27, there is shown a side view of the front side wall for the unopened 30-day tablet dispensing container. The front part of lid 404 is visible on the front side wall. Lid 404 is removed by the patient or a caregiver in order to access the contents of the container 400. By way of example, the front lid 404 and the space below the lid have areas that display the name of the pharmacy that provides the container 400.

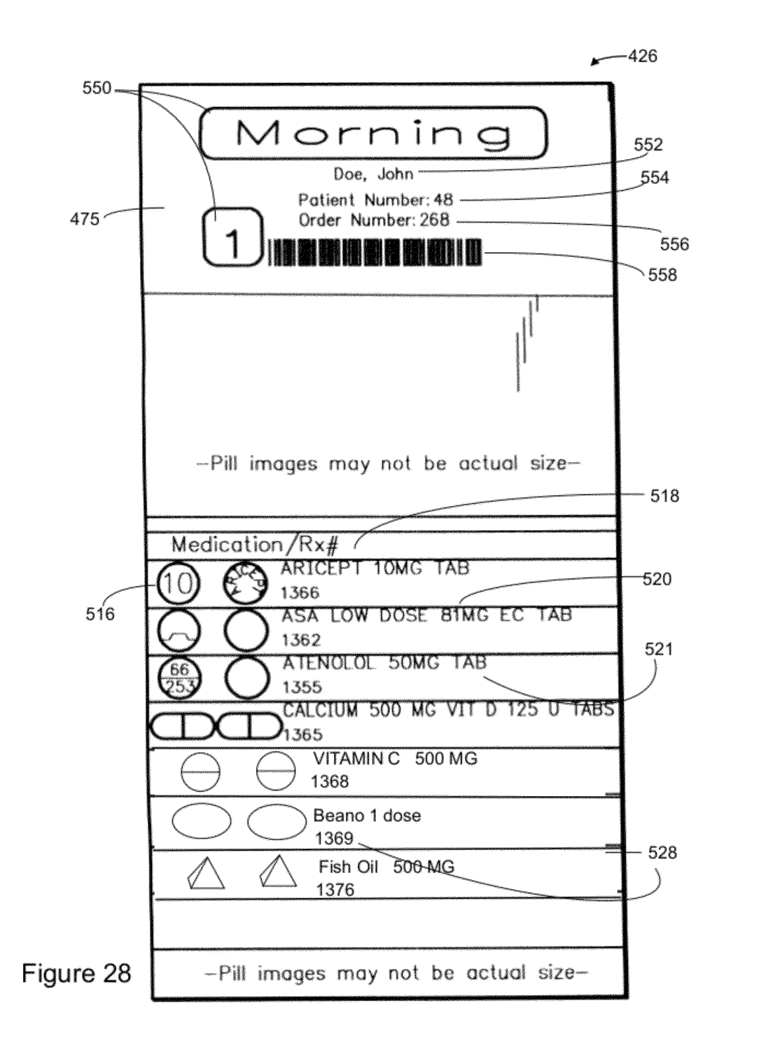

Referring to FIG. 28 there is shown a side view of the back side wall of the 30-day tablet dispensing container. Part of the primary label 500 is shown affixed to the lower portion of the back side wall 426 of the container 400. Additionally, part of the secondary label 475 is also shown. The visible portion of the primary label 500 includes the medicament and nutraceutical images 516, the medicament or nutraceutical name 518, the dosage amount 520, the dosage format 521, and the drug number 528 is shown. The upper portion of the back side wall 426 of container 400 includes a portion of the secondary label 475 that also has additional printed information that includes dosage period 550, patient name 552, patient number 554, order number 556, and barcode 558.

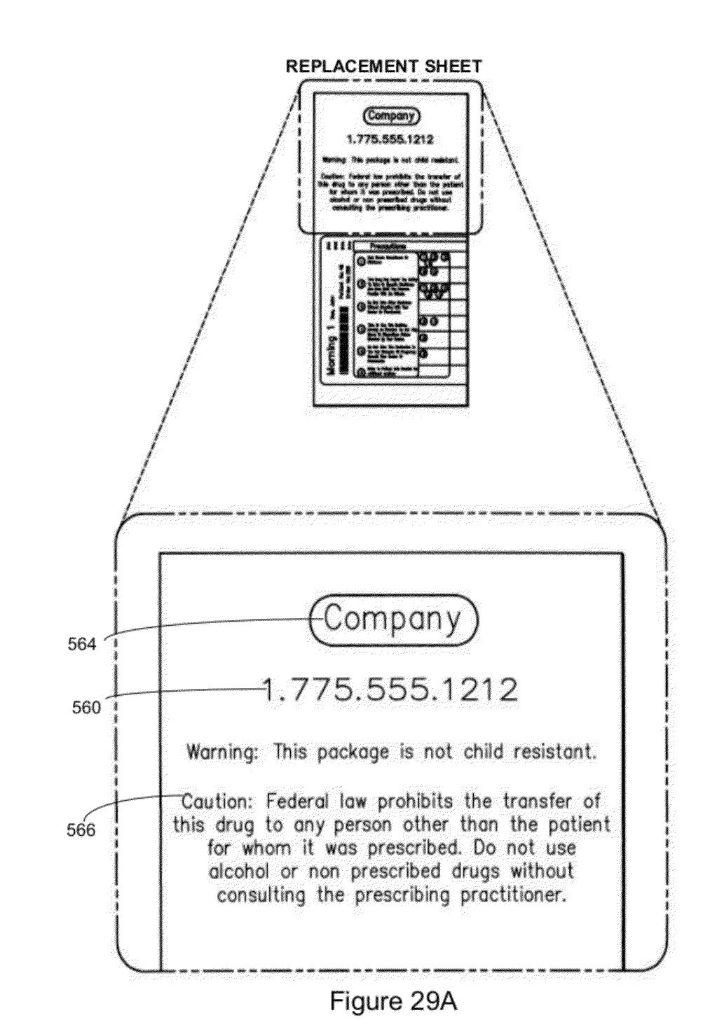

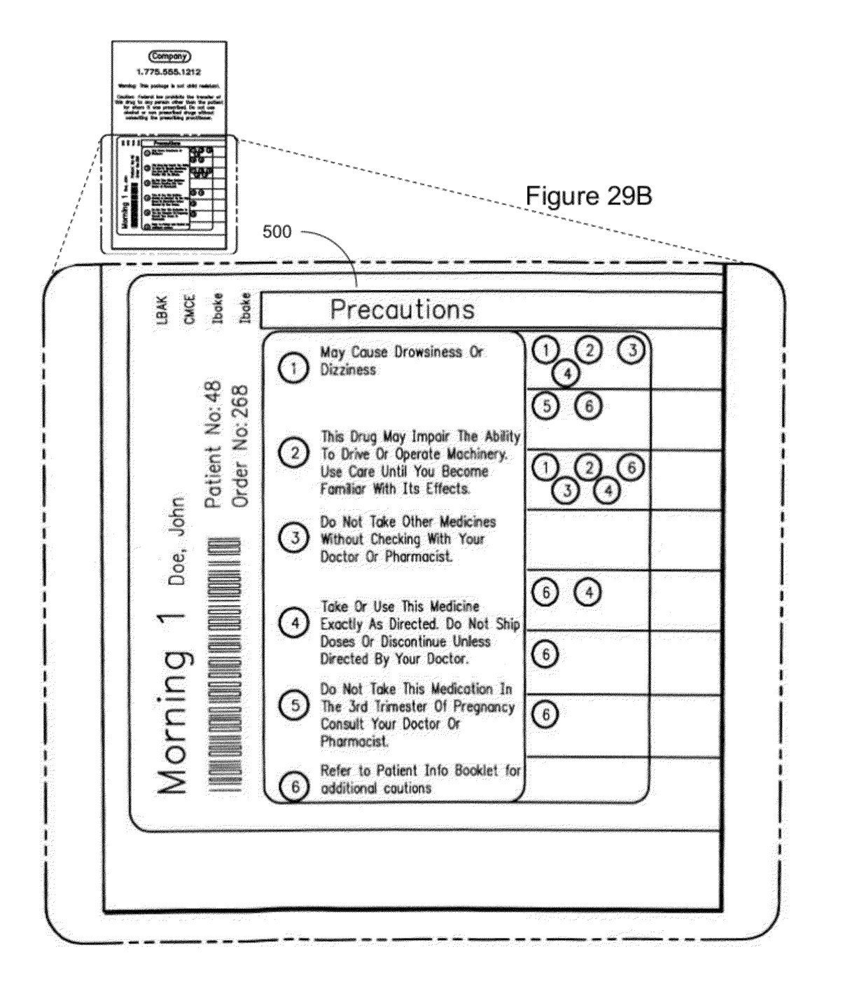

Referring to FIGS. 29A-29B, there is shown a side view of the illustrative right-side wall of the 30-day tablet dispensing container. The visible portion of primary label 500 is affixed to the lower portion of right side wall 420. The visible label portion includes the time period 502, patient name 504, barcode 506, patient number 508, order number 510, numbers 512A associated with precautions 514 (not shown), and numbers 512B. In this illustrative embodiment, the upper portion of the right side 420 includes pharmacy name 564 and contact telephone/facsimile number 560. In this illustrative embodiment, the right side 420 also includes certain additional legal information or warnings 566 regarding the package and its contents.

During the process of assembling and filling the 30-day tablet dispensing container, bar code 558 may be printed or affixed to the back of an assembled, unfilled container before any other patient-specific information is applied. Then, as the process continues, barcode 506 from the illustrative label 500 may be compared to barcode 558 that is already present on the unfilled container before the label 500 is affixed to the container. Lastly, the barcode 564 that is found on the back of each tablet pouch may be compared with the barcode 506 disposed on the label 500 and/or the barcode 558 disposed on the back side of the container. If the barcodes are properly associated, i.e. they “match”, then the strip of packets will be placed into the associated container before sealing the container. The barcode scanning can be accomplished with hand-held devices or may be automated.

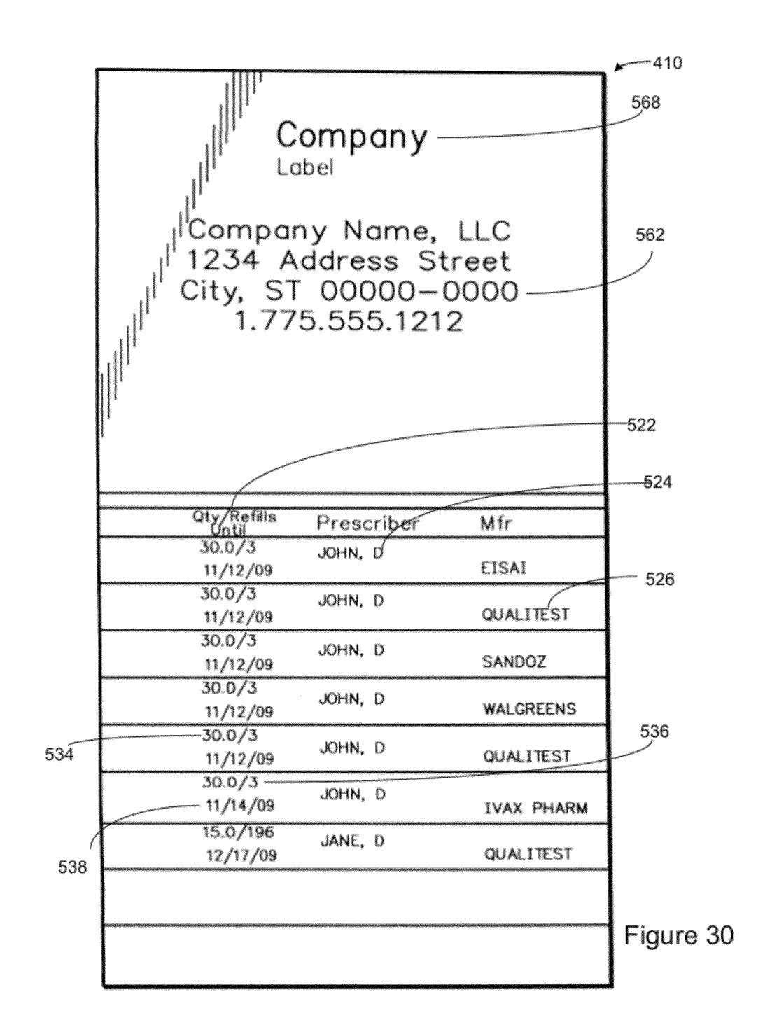

Referring to FIG. 30 there is shown a side view of the illustrative left-side wall of the 30-day tablet dispensing container. The visible portion of primary label 500 is affixed to the lower portion of left side wall 410. The label portion includes the refill information 522 including quantity 534, number of refills 536, the date that the prescription is good through 538, prescribing practitioner names 524, and manufacturer information 526. In this illustrative embodiment, the upper portion of the left side 410 includes illustrative pharmacy name 568 and contact address 562.

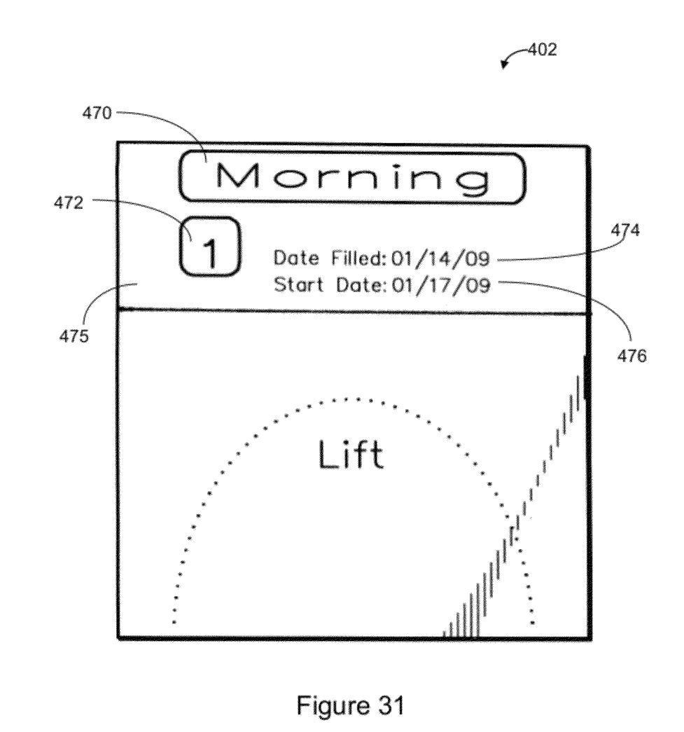

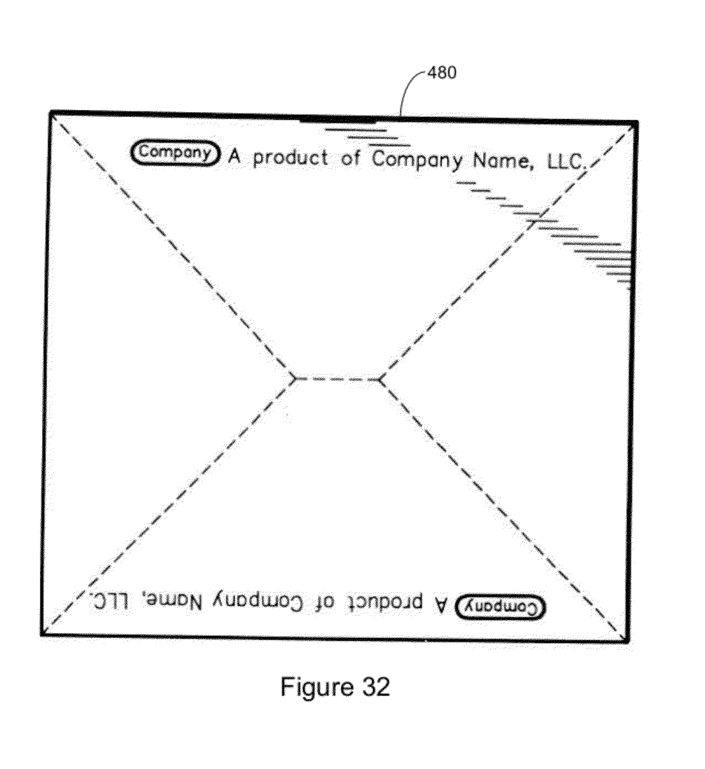

In FIG. 31 there is shown a top view of the top wall of the unopened 30-day tablet dispensing container. The top wall 402 includes the dosage period 470, the dosage period number 472, the date that the prescription was filled 474, and the date that marks the first day of the about 30-day period during which the enclosed medicaments should be taken 476. A bottom view of the 30-day tablet dispensing container is shown in FIG. 32 that includes folded elements and glued elements of the container that make up the bottom wall 480 when the foldable box is assembled.

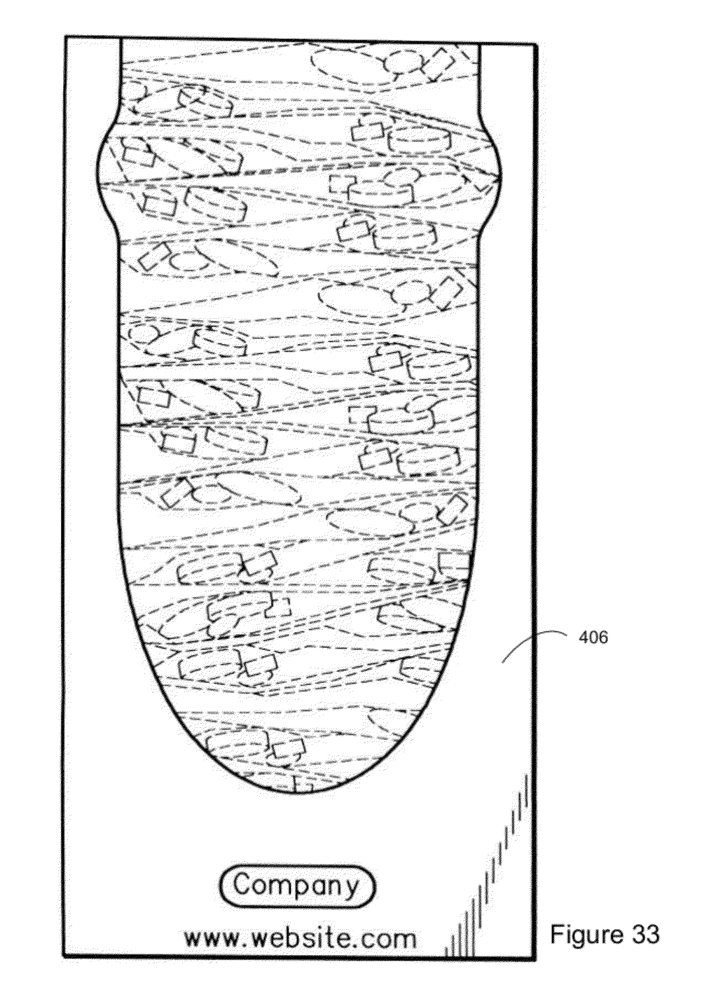

Referring to FIG. 33 there is shown an illustrative front view of the opened 30-day tablet dispensing container that reveals illustrative pouches where the front lid 404 (not shown) has been removed to reveal medicament packets within. Typically, the lid is removed after the user verifies that the medications are prescribed to the person that is about to take the medication by checking the patient name. The user would then verify that the time period on the illustrative container 400 corresponds to the current time of day. If this is the first time the container has been used, the illustrative user would then remove the lid 404 from the top 402 and/or the front 406 of the illustrative container 400 to reveal the contents. Next, the user would reach into the container and remove the first packet or pouch that contains medicaments. The user would then verify that the pouch or packet has the current date before opening the pouch. While the user may also re-verify that the pouch or packet also has the correct patient name and dosage period, this step is unnecessary due to the barcode verification (described above) used during the filling process.

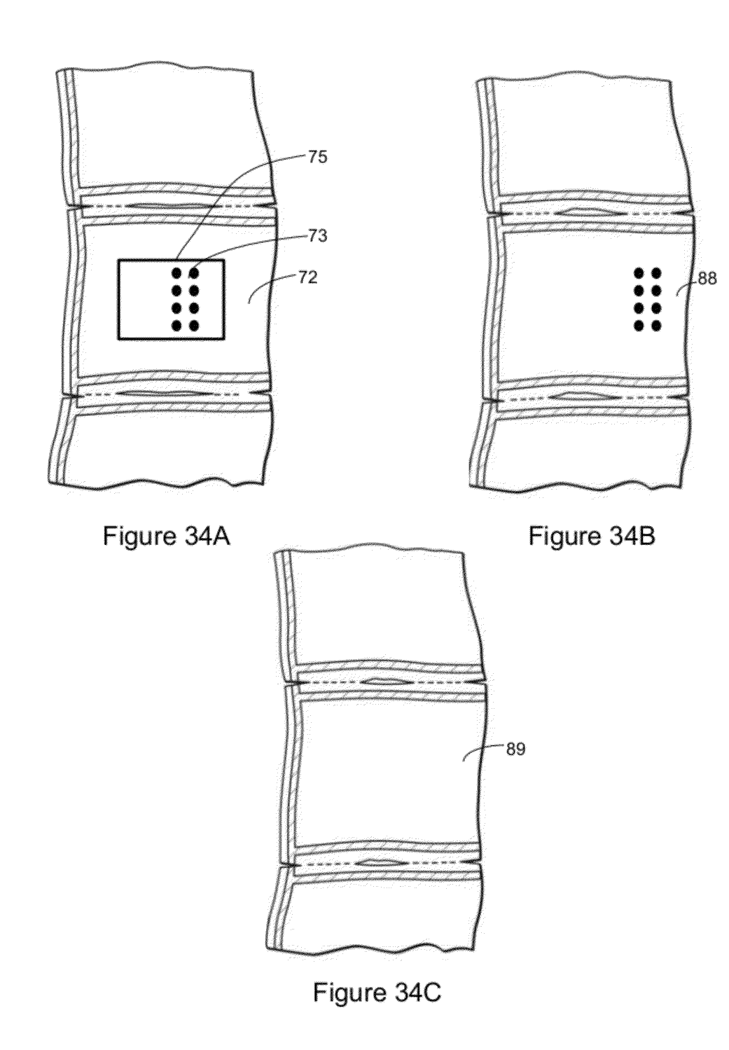

Referring to FIG. 34A there is shown the illustrative sealed center cut pouch 72 described above with three perforations and four tearable ribbons on each side of the center cut. In FIG. 34B there is shown an illustrative sealed center cut pouch 88 with four perforations on each side of the center cut. FIG. 34C depicts another illustrative sealed center cut pouch 89 with five perforations on each side of the center cut. Once the user has verified that the pouch removed from the container is for the correct person, date, and time period, the user may then open the pouch. The user will then administer the medication to the patient (himself or someone else). The patient will take the medication and discard the empty pouch. The process will be repeated for the next dosage period, such as mid-day.

The illustrative pouch described above can be opened with only one hand, making it easier for those with limited motion to self-administer even complex medication regimens. In this way, the 30-day tablet dispensing container system described herein provides a compliance mechanism that is simple to understand and intuitive to use for patients and caregivers alike.

The illustrative 30-day tablet dispensing container offers additional benefits for those with a variety of conditions that affect speech and/or upper limb mobility, including but not limited to disorders like arthritis, effects of a stroke or early stage dementia. Many of these patients develop their conditions later in life, and these patients may dislike relying on a caregiver to provide information to physicians or to self-administer complex medication regimens. The 30-day tablet dispensing container system helps these patients address both issues. For a patient, the illustrative 30-day tablet dispensing container provides drug regimen information and facilitates communication with a physician, a nurse, a third party, a spouse, a caregiver or other such individual. The 30-day tablet dispensing container also allows the illustrative patient to maintain independence by taking charge of their own medications.

The resulting pouch can be opened on either side and the center cut prevents tearing the existing pouch or the adjacent pouch. In general, the pouch described minimizes the number of tearable ribbons, thereby minimizing the likelihood of tearing the existing pouch or the adjacent pouch. Additionally, having the tearable ribbons at the edges of the pouch also minimizes the likelihood of tearing into the existing or adjacent pouches.

It shall be appreciated by those of ordinary skill in the art having the benefit of this disclosure that the resulting pouch will vary depending on the type of pouch material being used, the thickness or weight of the pouch material, the seal, the length of the cuts, the number of cuts, the length of the perforations, number of perforations, the width of the tearable ribbons and the frequency of tearable ribbons.

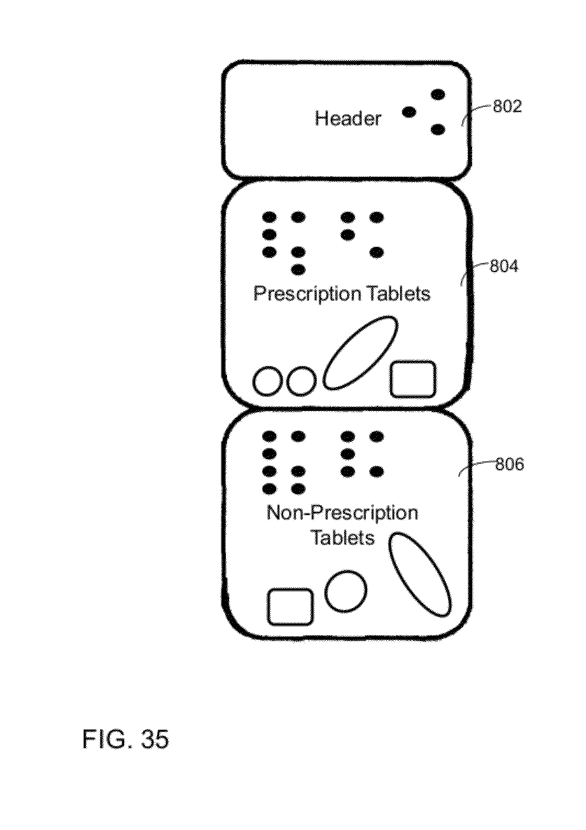

Referring to FIG. 35 there is shown an illustrative layout of pouches associated with all tablets to be consumed by one individual at a particular date and time and associated with an illustrative individual regimen. Header 802 does not contain any tablets. Instead, illustrative information is provided. Pouch 804 represents a pouch containing tablets associated with one or more prescriptions associated with an illustrative individual regimen. Pouch 806 represents a pouch containing non-prescription tablets associated with an illustrative individual regimen.

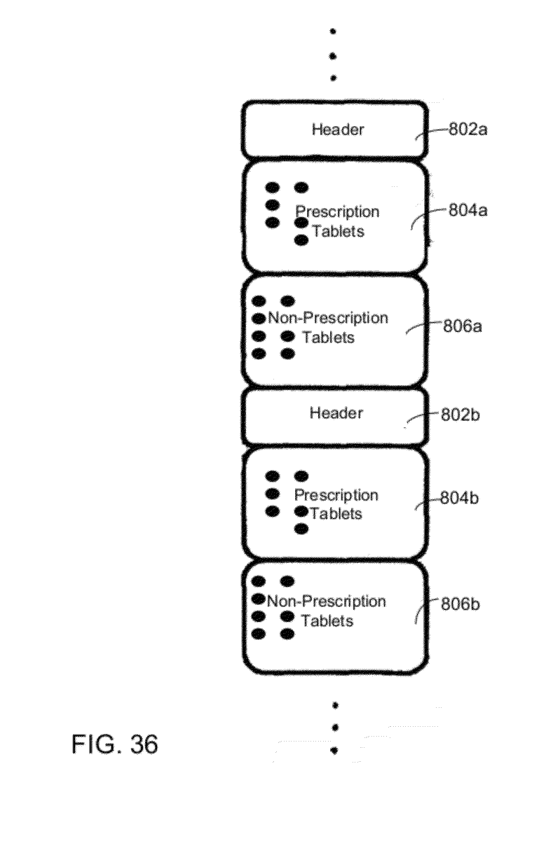

Referring to FIG. 36 there is shown a portion of the layout of a strip of pouches associated with an illustrative individual regimen, showing that the header 802a and the associated pouches 804a and 806a to be administered at one date and time are continuous with the header 802b and pouches 804b and 806b for the subsequent date and time. As shown, a dosage unit comprising a header and at least one pouch may be continuous with one or more dosage units.

A low-vision packaging system is described. The low-vision packaging system includes a plurality of preliminary containers, a final package, a prescribed time of day and a tactile indication. Each of the preliminary containers includes a plurality of tablets. As described above the preliminary containers include pouches, cups, vials or any other container that can house the different tablets associated with the particular dosage period.

The final package is configured to receive the plurality of preliminary containers and dispenses the preliminary containers. As described the final package includes the cardboard box and the spiral dispenser described above.

As described above, the prescribed time of day is associated with the low vision packaging system and identifies the time of day for consuming the plurality of tablets enclosed by the preliminary containers that are housed by the final package. For example, the cardboard box shown in FIG. 25A has a particular time of day, namely, morning associated with the medications.

The tactile indication is also associated with the low vision packaging system and identifies the prescribed time of day for consuming the tablets. The tactile indication may include Braille characters, tactile symbols or the combination thereof. For example, the tactile indication may be included in an embossed label that is adhesively coupled to the illustrative cardboard box final package container as shown in FIG. 25.

More particularly, FIG. 25A shows a tactile indication 471 that is embossed into secondary label 475 that is adhesively coupled to the box. The tactile indication 471 represents a “Morning” dosage. In this embodiment, the tactile indication includes a label with a Braille component or tactile symbol that is adhesively coupled to the final package, and the Braille component or tactile symbol corresponds to the prescribed time of day for consuming the tablets. A Gemini Print and Braille Embosser from Nippon Telesoft may be used to generate a Braille label with print in a single pass.

Also, the top wall 402 of box 400 may be embossed with the tactile indication 473 as shown in FIG. 25A. Thus, the tactile indication 473 may include a Braille indicia or tactile symbol that is embossed on the final package that is associated with the prescribed time of day.

In yet another embodiment, the tactile indication 73 includes a Braille indicia or tactile symbol that is embossed on at least one of the preliminary packages such as shown in FIG. 34A. In this embodiment, a tactile symbol is embossed on at least one of the preliminary packages.

In addition to tactile indications, color indicia may also be used. For example, in FIG. 25A color indicia 477 is associated with the dosage period 470 by having the background of the morning text string be a separate color, e.g. orange. Thus, the color indicia 477 is associated with text that says “Morning” and with the tactile indication 477.

In another embodiment, the color indicia may be associated with the at least one of the preliminary containers. For example, in FIG. 34A the color indicia 75 corresponds to the prescribed time of day for consuming the tablets housed in each preliminary package. The color indicia 75 may be used in conjunction with the tactile indication 73 to communicate the prescribed time of day.

A package for blind or low-vision patients is described above. The package includes preliminary containers, a final package, a prescribed time of day for consuming the plurality of tablets, and a tactile indication. As described above, each preliminary container includes a plurality of tablets.

The final package receives the preliminary containers and dispenses the preliminary containers. The package includes a prescribed time of day for consuming the tablets that are enclosed by the preliminary containers that are housed by the final package.

The illustrative tactile indication is associated with the prescribed time of day for consuming the tablets. The tactile indication may include a tactile symbol that provides a tactile representation that is associated with the prescribed time of day for consuming the tablets. The tactile indication may also include an alphanumeric character that is associated with the prescribed time of day for consuming the tablets. Further still, the tactile indication may include Braille. The tactile indication may be generated using one or more of the different illustrative processes as described below.

In a first illustrative embodiment, a “layered” tactile indication is generated by applying multiple layers of toner, ink, or the combination thereof to produce tactile indicia. The multi-layer tactile indicia may be used with alphanumeric lettering, tactile symbols, Braille and other tactile communication techniques for low-vision patients.

In a second illustrative embodiment, raised ink or thermographic printing may also be used to generate the tactile indication. Thermography is a post print process that is achieved using traditional printing methods and thermography machines. The thermography process includes multiple process steps. The first process applies powdered polymer to the entire sheet and the second process includes a vacuum system that removes excess powder. The third process conveys the product through a radiant oven where the powdered polymer is exposed to temperatures ranging between 900 to 1300 degrees Fahrenheit. The raised ink processes work effectively with preliminary packages and/or final packages that are manufactured with materials that are not affected the relatively high temperatures associated with the raised ink processes.

In a third illustrative embodiment, the tactile indication is pressed or stamped. The stamped tactile indicia may be used with alphanumeric lettering, tactile symbols, Braille and other tactile communication techniques for low-vision patients.

In a fourth illustrative embodiment, an embosser is used to generate the tactile indication. By way of example and not of limitation, the embosser is a Braille embosser, which is an impact printer that renders text as tactile Braille cells. Braille printers do the actual embossing of Braille on to paper. Braille embossing printers are impact printers that rely on a forcible impact similar to the action of a typewriter. They use solenoids to control embossing pins, they typically print on heavy weight paper and require more pages than print, and they are much slower and noisier. By way of example and not of limitation, a Braille embosser uses a separate air compressor to drive the embossing head and can output up to 800 Braille characters per second. Braille embossers usually need special Braille paper which is thicker and more expensive than normal paper. Some high-end embossers are capable of printing on normal paper. Embossers can be either one-sided or two-sided. Once one copy of a document has been produced, printing further copies is often quicker by using thermographic printing.

In a fifth illustrative embodiment, an inject printer is used to generated the tactile indication. By way of example and not of limitation, the Scodix SENSE™ may be used to print Braille letters and graphic elements digitally that are up to 250 microns in thickness. The illustrative Scodix SENSE™ product employs a jetting block and multiple independently controlled inkjet nozzles that produce UV polymer in small drops and multiple layers. The Scodix Optical Print Alignment (OPA) camera system scans each and every sheet to ensure delivery of the Scodix PolySENSE™ clear polymer to its exact location. Printed substrates are run under a UV bulb that instantly cures the jetted Scodix PolySENSE™ clear polymer.

Thus, the tactile indication is selected from the group consisting of a layered printing media, a thermographic printing media, a stamped printed impression, an embossed printed impression, and an inkjet print impression. The tactile indication may also be combined with color. For example, different colors can be used in combination with a tactile indication for the low-vision patients. The color may be used to represent alphanumeric lettering and/or symbols, which relate to the prescribed time of day for consuming the tablets. The color indicia may be located on the preliminary package, the final package or the combination thereof. By way of example and not of limitation, the color indicia is selected from the group consisting of white color, gray color, black color, pink color, red color, orange color, yellow color, green color, blue color, purple color and brown color. Hatching and/or cross-hatching techniques may also be used to represent alphanumeric lettering and symbols that can related to the prescribed time of day for consuming the tablets.

Additionally, the tactile indication and color print can be used to identify the individual, the day of the week and any other information associated with the label as described above. The tactile indication associated with the prescribed time of day for consuming the tablets may be located on the preliminary package, the final package or the combination thereof.

It is to be understood that the foregoing is a detailed description of illustrative embodiments. The scope of the claims is not limited to these specific embodiments or examples. Therefore, various elements, details, execution of any methods, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A package for blind or low-vision patients, the package comprising:
a plurality of preliminary containers, wherein each preliminary container includes a plurality of tablets;
a final package configured to receive the plurality of preliminary containers and dispenses the preliminary containers;
a prescribed time of day for consuming the plurality of tablets enclosed by the preliminary containers that are housed by the final package; and
a tactile indication associated with the prescribed time of day for consuming the tablets.

2. The package of claim 1 wherein the tactile indication comprises at least one tactile symbol that provides a tactile representation that is associated with the prescribed time of day for consuming the tablets.

3. The package of claim 2 wherein the tactile indication comprises at least one alphanumeric character that is associated with the prescribed time of day for consuming the tablets.

4. The package of claim 2 wherein the tactile indication is selected from the group consisting of a layered printing media, a thermographic printing media, a stamped printed impression, an embossed printed impression, a Braille indicia impression and an inkjet print impression.

5. The package of claim 1 wherein the tactile indication associated with the prescribed time of day for consuming the tablets is located on the preliminary package.

6. The package of claim 1 wherein the tactile indication associated with the prescribed time of day for consuming the tablets is located on the final package.

7. The package of claim 1 wherein the tactile indication associated with the prescribed time of day for consuming the tablets is located on the preliminary package and the final package.

8. The package of claim 1 wherein the tactile indication further comprises a Braille indicia on the final package.

9. The package of claim 1 wherein the tactile indication further comprises a Braille indicia on at least one of the preliminary packages.

10. The package of claim 1 further comprising a color indicia associated with the prescribed time of day for consuming the tablets housed in each preliminary package.

11. The package of claim 10 wherein the color indicia is selected from the group consisting of white color, gray color, black color, pink color, red color, orange color, yellow color, green color, blue color, purple color and brown color.

12. A package for blind or low-vision patients, the package comprising:
a plurality of preliminary containers, wherein each preliminary container includes a plurality of tablets;
a final package configured to receive the plurality of preliminary containers and dispenses the preliminary containers;
a prescribed time of day for consuming the plurality of tablet enclosed by the preliminary containers that are housed by the final package;
a color indicia that corresponds to the prescribed time of day for consuming the tablets housed in each preliminary package; and
a tactile indication associated with the prescribed time of day for consuming the tablets housed in each preliminary package.

13. The package of claim 12 wherein the color indicia is selected from the group consisting of white color, gray color, black color, pink color, red color, orange color, yellow color, green color, blue color, purple color and brown color.

14. The package of claim 13 further comprising at least one alphanumeric character that is associated with the prescribed time of day for consuming the tablets.

15. The package of claim 14 wherein the tactile indication comprises at least one tactile symbol that provides a tactile representation that is associated with the prescribed time of day for consuming the tablets.

16. The package of claim 15 wherein the tactile indication is selected from the group consisting of a layered printing media, a thermographic printing media, a stamped printed impression, an embossed printed impression, a Braille indicia impression and an inkjet print impression.

17. The package of claim 16 wherein the tactile indication associated with the prescribed time of day for consuming the tablets is located on the preliminary package.

18. The package of claim 16 wherein the tactile indication associated with the prescribed time of day for consuming the tablets is located on the final package.

19. The package of claim 16 wherein the tactile indication associated with the prescribed time of day for consuming the tablets is located on the preliminary package and the final package.

20. A package for blind or low-vision patients, the package comprising:
a plurality of preliminary containers, wherein each preliminary container includes a plurality of tablets;
a final package configured to receive the plurality of preliminary containers and dispenses the preliminary containers;
a prescribed time of day for consuming the plurality of tablet enclosed by the preliminary containers that are housed by the final package;
a color indicia that corresponds to the prescribed time of day for consuming the tablets housed in each preliminary package, wherein the color indicia is selected from the group consisting of white color, gray color, black color, pink color, red color, orange color, yellow color, green color, blue color, purple color and brown color;
at least one alphanumeric character that is associated with the prescribed time of day for consuming the tablets; and
a tactile indication that includes at least one tactile symbol that provides a tactile representation that is associated with the prescribed time of day for consuming the tablets.

21. The package of claim 20 wherein the tactile indication is selected from the group consisting of a layered printing media, a thermographic printing media, a stamped printed impression, an embossed printed impression, a Braille indicia impression and an inkjet print impression.

22. The package of claim 21 wherein the tactile indication associated with the prescribed time of day for consuming the tablets is located on the preliminary package.

23. The package of claim 20 wherein the tactile indication associated with the prescribed time of day for consuming the tablets is located on the final package.

24. The package of claim 20 wherein the tactile indication associated with the prescribed time of day for consuming the tablets is located on the preliminary package and the final package.
